(19) United States
(12) Patent Application Publication
(10) Pub. No.: US 2005/0216124 A1
(43) Pub. Date: Sep. 29, 2005

(54) Mobile robot for monitoring a subject

(75) Inventor: Kaoru Suzuki, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/064,931

(22) Filed: Feb. 25, 2005

(30) Foreign Application Priority Data
Feb. 26, 2004 (JP) 2004-52425

(51) Int. Cl. G06F 19/00

(52) U.S. Cl. 700/253; 700/245

(57) ABSTRACT

A mobile robot with a diagram indicating a moving path of a subject and a diagram showing a connection between locations, is capable of generating a path on which a subject is predicted to move from information of the subject detected by a detector, a detecting direction of the detector along the path, or tracking the subject by tracing the path, and predicting a location of a destination of the subject even when the subject has moved to another location. Further, the robot is capable of determining an abnormality based on detected location of the subject.

### CROSS-REFERENCE TO RELATED APPLICATIONS

This application is based upon and claims the benefit of priority from the prior Japanese Patent Application No. 2004-052425 filed on Feb. 26, 2004 the entire contents of which are incorporated herein by reference.

### FIELD OF THE INVENTION

The present invention relates to a mobile robot moved by utilizing map information, particularly to a mobile robot able to track a user by predicting a moving path of the user by utilizing map information.

### DESCRIPTION OF THE RELATED ART

In recent years, various robots sharing common space with human beings have been presented. Accordingly, it is conceivable to use a robot to monitor whether a user (subject) is safe by tracking the user. For example, when a user lives in a house by oneself, there may be a case in which, even when an abnormal situation is brought about, the user cannot call for help. In this case, when a robot detects an abnormality of the user, the user can be made safe by immediately communicating the abnormality to a monitor center. In order to operate as described above, a robot needs to be able to perform at least two functions; a function of searching for and tracking a user and a function of detecting the abnormality of the user.

With regard to the function of searching for and tracking the user, it is necessary to provide an ability to move the robot to a location where the user is present and map information with regard to a space in which the robot can move (is movable). Accordingly, the robot uses two kinds of map information, a work space map and a network map.

The work space map refers to a map describing, for example, geometrical information about a space in which a robot can be moved. The robot analyzes a shape of the movable space and generates information of a moving path satisfying a predetermined condition. The robot moves within the space by following information of the generated moving path. Other than the above-described use, when an unknown hazard is detected in a movable space by a sensor, the work space map is applied also to avoid the hazard by adding the hazard to work space map information and regenerating information of the moving path (see (Kokai)JP-A-2001-154706 and (Kokai)JP-A-8-271274).

According to JP-A-2001-154706, a hazard is described in a shape of a lattice on a two dimensional plane and a path of a moving member is calculated and generated by searching potential field calculated surrounding the hazard in accordance with a distance thereto.

According to JP-A-8-271274, in order to move a robot used outdoors on irregular ground while avoiding a large inclination, height information is added to a two-dimensional plane lattice and a moving path is calculated and generated based thereon.

A network map refers to a map indicating, for example, each representative position with a node and describing a relationship among the respective representative positions with links connecting the nodes. The robot generates information of a moving path that satisfies a predetermined condition to reach one node from a another node. Further, when information about the distance between nodes is added to the respective links, a path satisfying a condition of a total length of the moving path or a shortest possible path can be calculated and generated.

Further, there is an optimum path searching method utilizing a network map capable of actually moving a robot in accordance with information of a generated path when orientation information of respective links connecting to nodes is added (see (Kokai)JP-A-5-101035).

When a location of a user is set as a destination by utilizing the above-described two kinds of map information, a path from a current position of a robot to a destination can be calculated and generated. Information about a location by which a robot constitutes a moving path from a certain location to a location of a user can be generated by utilizing the network map. Further, moving paths in respective locations and a moving path when a robot and a user are present in the same location can be generated by utilizing the work space map.

Further, there is a method of detecting an abnormality of a user by providing an abnormality determining reference in relation with a section where a robot is present within a predetermined path where the robot patrols (refer to (Kokai)JP-A-5-159187).

### SUMMARY OF THE INVENTION

A mobile robot according to one aspect of the present invention includes a storage device configured to store movable path information indicating a path on which a user can move, a detector for detecting the user and acquiring user position information indicating a position and a direction from the robot at which the detected user is present, moving path predicting generator configured to generate predicted moving path information indicating a path on which the user is predicted to move from the movable path information stored to the storage and the user position information detected by the detector, and detecting direction controller for carrying out a control of changing an angle of the detector to a moving direction of the user predicted by the predicted moving path information generated by the moving path predicting device.

According to another aspect of the present invention, there is provided a mobile robot including a storage device configured to store abnormality determination reference information indicating a determination reference for detecting an abnormality at respective locations to which a subject may move; a detector configured to detect action information indicating a sound made by the subject in the location in which the subject is present; an abnormality determination reference setting unit configured to set the abnormality determination reference information stored in the storage device in correspondence with the location where the subject is present; and an abnormality determining unit configured to determine whether the action information detected by the detector is abnormal based on the abnormality determination reference information set by the abnormality determination reference setting unit.

According to another aspect of the present invention, there is provided a method of monitoring a subject, including first detecting a location of a subject by means of at least one sensor mounted on a mobile robot; monitoring movement of the subject based on changes of a detected location of the subject; moving the mobile robot to maintain proximity between the subject and the mobile robot; second detecting at least one characteristic of the subject at one or more locations of the mobile robot; and outputting a signal representative of the detected characteristic of the subject.

According to another aspect of the present invention, there is provided a mobile robot including a storage device configured to store a map of a locality; a detector configured to detect action of a subject within a detection range; means for maintaining the detector in proximity to the subject; and means for determining at least one characteristic of the subject.

According to another aspect of the present invention, there is provided a computer program product which stores computer program instructions which, when executed by a computer programmed with the computer program instruction, results in performing the steps including receiving first data from a first sensor mounted on a mobile robot and determining the location of a subject based on the received first data; determining changes of a detected location of the subject based on the first data; generating drive signals to a movement portion of a mobile robot to maintain proximity between the subject and the mobile robot; receiving second data from a second sensor at one or more locations of the mobile robot, said second data related to at least one characteristic of the subject; and outputting a signal representative of the detected characteristic of the subject.

### BRIEF DESCRIPTION OF THE DRAWINGS

The invention is best understood from the following detailed description when read in conjunction with the accompanying drawings.

FIG. 1 is a functional block diagram according to a first embodiment of a mobile robot;

FIG. 2 is a view showing information held by a map information storing portion according to the first embodiment of the mobile robot;

FIG. 3 is a view showing a constitution of a location where a user can be moved by movable location constituting data according to the first embodiment of the mobile robot;

FIG. 4 is a plan view showing an example of a movable space view of a living location 56 held at the map information storing portion according to the first embodiment of the mobile robot;

FIG. 5 is a plan view showing an example of a movable path of the living location 56 held at the map information storing portion according to the first embodiment of the mobile robot;

FIG. 6 is a of a functional block diagram of a detector according to the first embodiment of the mobile robot;

FIG. 7 is a schematic illustrative of a user detecting region according to the first embodiment of the mobile robot;

FIG. 8 is a view showing abnormality detection setting reference information provided for respective locations in the movable location data according to the first embodiment of the mobile robot;

FIG. 9 is a flowchart showing processing according to the first embodiment of the mobile robot;

FIG. 10 is a flowchart showing processing of a detector and a user position determining portion according to the first embodiment of the mobile robot;

FIG. 11 is a diagram showing a method of selecting a predicted path of a user according to the first embodiment of the mobile robot;

FIG. 12 is a flowchart showing processing before tracking to move according to the first embodiment of the mobile robot;

FIG. 13 is a view showing a relationship between a user disappearing direction and an accessible region to a user according to the first embodiment of the mobile robot;

FIG. 14 is a view showing a method of tracking a user using a user detecting region according to the first embodiment of the mobile robot;

FIG. 15 is a view showing a distribution of a user presence expected value (locations where the user may be) when the time period (elapse time period) since losing sight of a user is short (elapse time period T1) according to the first embodiment of the mobile robot;

FIG. 16 is a view showing a distribution of the user presence expected value when the elapse time period since losing sight of a user is an intermediate amount of time (elapse time period T2) according to the first embodiment of the mobile robot;

FIG. 17 is a view showing a distribution of the user presence expected value when a long period of time has elapsed (elapse time period T3) since losing sight of the user according to the first embodiment of the mobile robot;

FIG. 18 is a graph showing a change of a user moving distance distribution in accordance with the elapse time period according to the first embodiment;

FIG. 19 is a graph showing the user presence expected value in correspondence with a moving distance derived from the user moving distance distribution according to the first embodiment;

FIG. 20 is a view showing a distribution of the user presence expected value differing by respective locations from a difference of the moving distance among locations according to the first embodiment of the mobile robot;

FIG. 21 is a graph showing a relationship between an elapse time period and a maximum user moving distance when a maximum value of the moving speed of a user does not exceed a certain value according to the first embodiment;

FIG. 22 is a graph showing the user presence expected value derived from the maximum possible user moving distance when the maximum value of the moving speed of the user does not exceed a certain value according to the first embodiment;

FIG. 23 is a side view of a location showing a relationship among sizes of a hazard, a user and a mobile robot according to a second embodiment;

FIG. 24 is a functional block diagram of the systems in a mobile robot according to the second embodiment of the mobile robot;

FIG. 25 is a view showing information held by a map information storing portion according to the second embodiment of the mobile robot;

FIG. 26 is a plan view showing an example of space in which a user of a living location 56 can move held in the map information storing portion according to the second embodiment of the mobile robot;

FIG. 27 is a plan view showing an example of the space in which a robot can move in the living location 56 held in the map information storing portion according to the second embodiment of the mobile robot;

FIG. 28 is a plan view showing a path on which a user can move in a space where the robot of the living location 56 can be moved according to the second embodiment of the mobile robot;

FIG. 29 is a flowchart showing processing when a path on which a user moves is predicted and tracked according to the second embodiment of the mobile robot;

FIG. 30 is a view showing a detour path derived for the mobile robot to track a user such that the mobile robot can avoid a hazard according to the second embodiment of the mobile robot; and

FIG. 31 is a view showing a detour path selected by the procedure of avoiding a hazard according to the second embodiment of the mobile robot.

### DETAILED DESCRIPTION

An exemplary embodiment of the invention will be explained in detail in reference to the attached drawings as follows.

### First Embodiment

The term “user” and the term “subject” used throughout this application include, but are not limited to, a person, multiple persons, and animals.

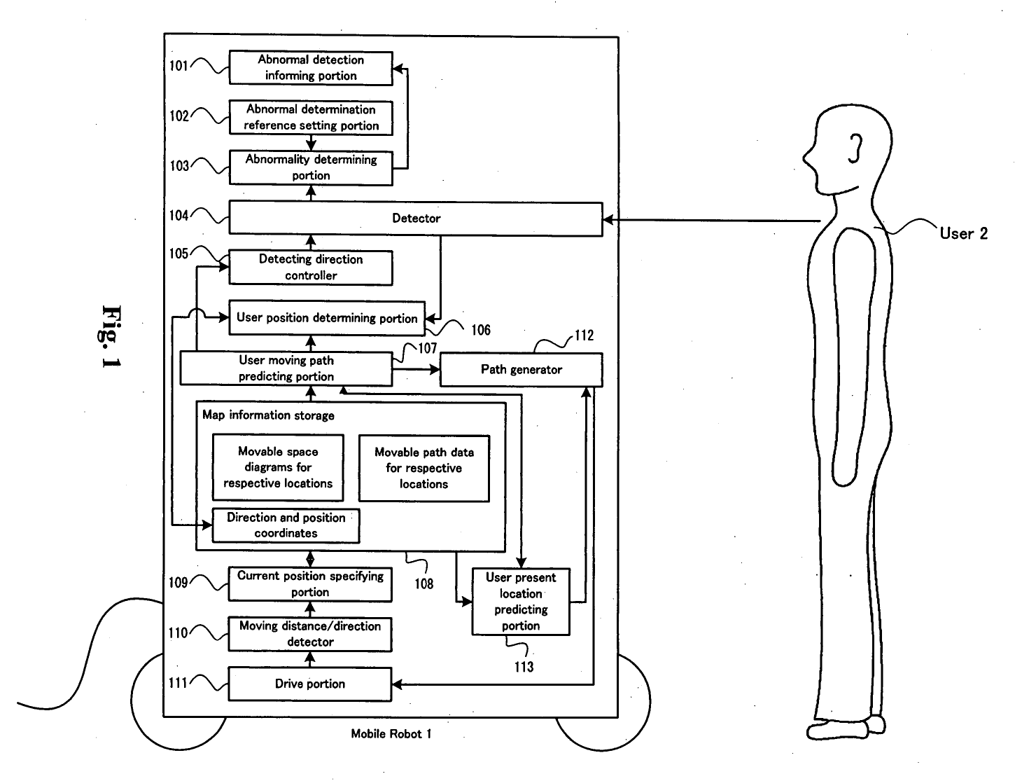

FIG. 1 is a block diagram showing the components of a mobile robot 1 according to a first embodiment of the invention in schematic form. As shown by FIG. 1, the mobile robot 1 shown in the embodiment includes an abnormal detection informing portion 101, an abnormal determination reference setting portion 102, an abnormality determining portion 103, a detector 104, a detecting direction controller 105, a user position determining portion 106, a user moving path predicting portion 107, a map information storage 108, a current position specifying portion 109, a moving distance/direction detector 110, a drive portion 111, a path generator 112, and a user present location predicting portion 113 for searching to track a user 2. FIG. 1 is not intended to in any way limit the physical location of the above-described portions within the box.

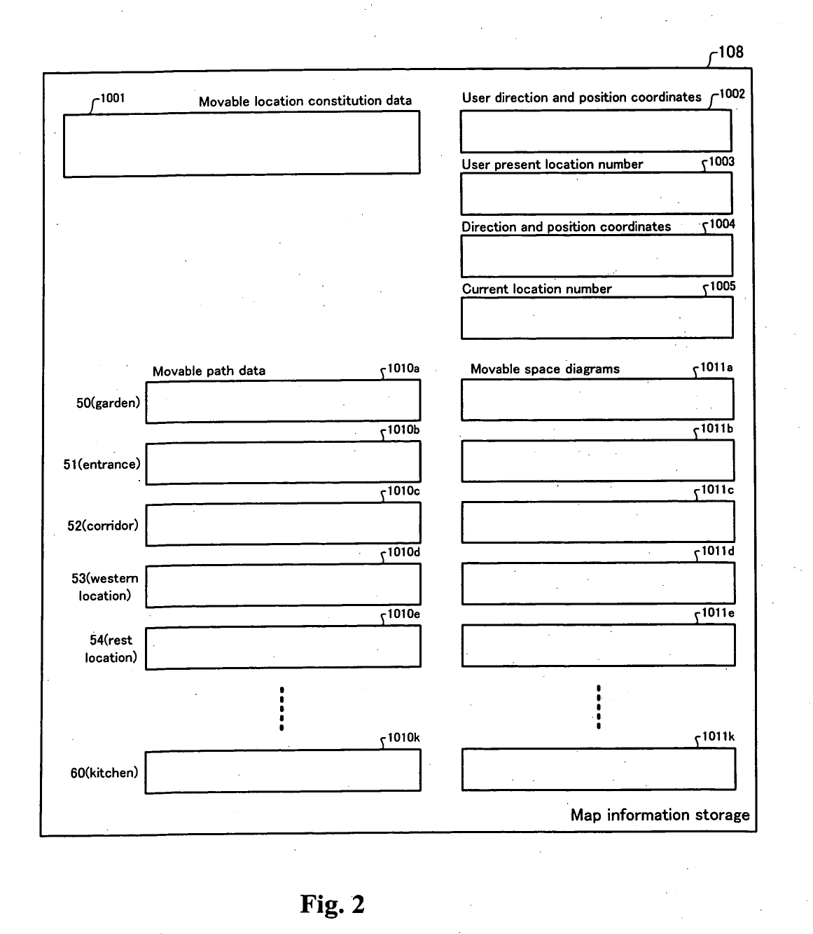

The map information storing portion 108 provides storage according to the invention and stores a constitution diagram of a location, map information for each location, information of current positions of the moving robot 1 and the user 2. FIG. 2 shows information held by the map information storing portion 108 according to the embodiment. The map information storing portion 108 is stored with movable location constitution data 1001, movable space diagrams for respective locations 1011a through k, movable path data 1010a through k user direction and position coordinates 1002, a user present location number 1003, direction and position coordinates 1004 and a current location number 1005. Thus, among other things, the map includes portions designated as accessible to the user (subject) and portions designated as accessible to the mobile robot.

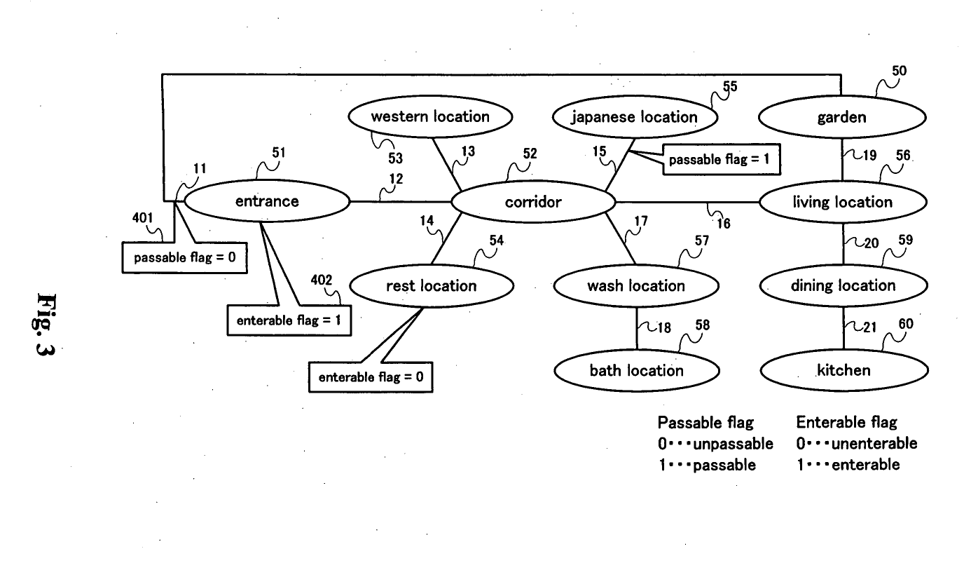

FIG. 3 illustrates the above-described movable location constitution data 1001. The movable location constitution data 1001 shows a constitution of a movable location in a house of a user 2, and respective key points of a garden 50, an entrance 51, a corridor 52, a western location 53, a rest location 54, a Japanese location 55, a living location 56, a wash location 57, a bath location 58, a dining location 59 and a kitchen 60 constitute key points of the invention. Further, link lines connecting the respective key points indicate inlets/outlets 11 through 21.

The movable location constitution data 1001 is described with all the spaces to which the user 2 is movable as the key points in the house of the user 2. Further, each key point is provided with an “enterable” flag 402 indicating whether the mobile robot 1 is “enterable” (may enter). Each link line is provided with a “passable” flag 401 indicating whether the mobile robot 1 is “passable” (may pass). Further, the map information storing portion 108 typically stores (with the movable space diagrams 1011 of an enterable key point) any unenterable key point contiguous thereto in order to at least track and detect the user 2 by the detector 104.

According to one embodiment, a limit is set to a traveling function of the mobile robot 1, and the mobile robot 1 is unable to enter the garden 50, the rest location 54 and the bath location 58. In this case, “0” is set to the respective enterable flags 402 and “1” is set to the enterable flag 402 of other locations. Further, the mobile robot 1 is set to be “unpassable” (prevented from passing) from the entrance 51 to the garden. In this case, “0” is set to the passable flag 401 and “1” is set to the other enterable flag 402. A case in which both of the passable flag 401 and the enterable flag 402 are to be used, is a case in which, even when the mobile robot 1 is passable to a certain key point, the mobile robot 1 cannot enter by passing a certain inlet/outlet but can enter by another detoured inlet/outlet. Therefore, depending on the layout of the location, with regard to the passable flag 402 and the enterable flag 402, both flags are not necessarily needed. Sometimes one of the flags is present, but not the other.

By including all the key points and all the link lines to which the user 2 is movable even when there are locations to which the mobile robot 1 is unenterable or inlets/outlets to which the mobile robot 1 is unpassable, the movable location constitution data 1001 describes not only path information for moving the mobile robot 1, but also describes paths to the key points to which only the user 2 is movable. Thus, using the movable location constitution data 1001, the robot 1 can search the user 2 even in locations the robot 1 cannot itself enter or reach.

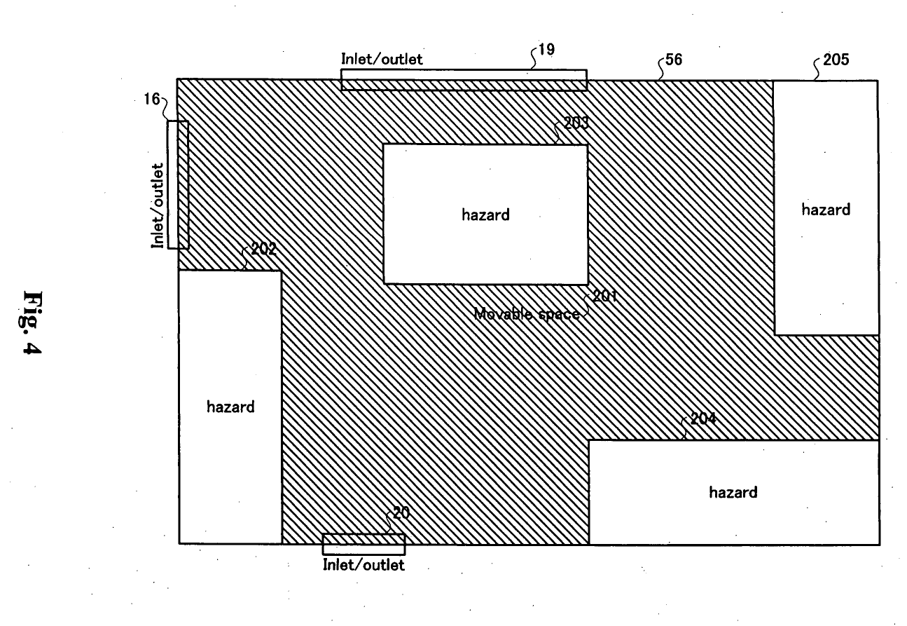

The mobile space diagrams 1011a through 1011k of the respective locations hold map information of the spaces of the respective locations to which the user 2 is movable. As an example, FIG. 4 shows the movable space diagram 1011g of the living location 56 and a space excluding hazards 202, 203, 204, 205 is set to a movable space 201 to which the user 2 is movable. In addition thereto, the movable space diagram 1011g holds information of inlets/outlets 16, 19, 20 to other compartments.

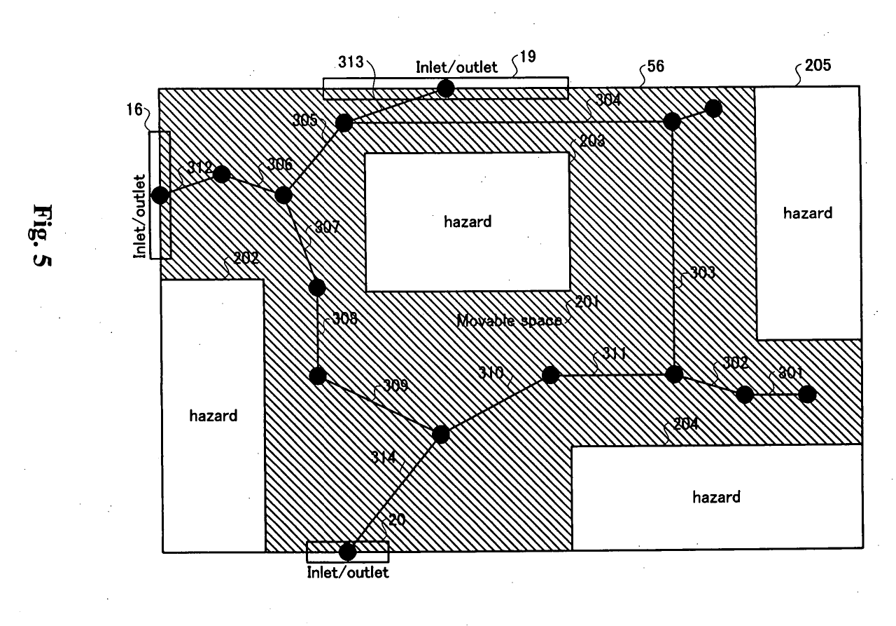

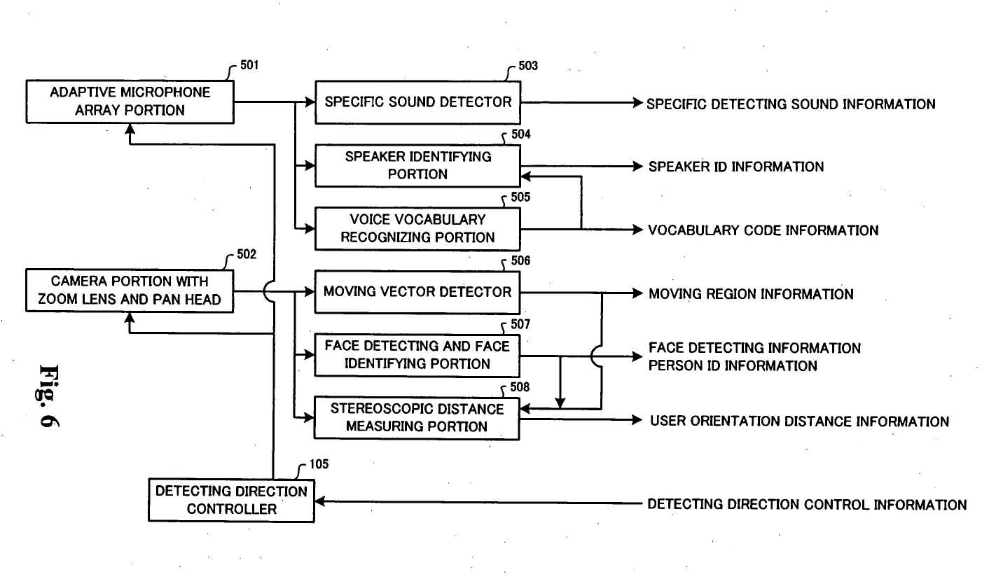

The movable path data 1010a through k of the respective compartments are held as data of movable paths of the user 2 on the movable space diagrams 1011 of the respective compartments. As an example, FIG. 5 shows path data on the movable space diagram 1011g of the living location 56. The movable path data comprises segments 301 through 311 indicating paths passing a center portion of the movable space 201, and additional segments 312 through 314 connecting centers of the respective inlets/outlets 16, 19, 20 and segment key points proximate thereto on the movable space 1011g. The segments 301 through 311 of the movable path data 1010g are generated by catching the movable space 201 of the movable space diagram 1011g as an image and subjecting the image to line segment processing (a process of leaving only a dot row at the center portion (of an image) by gradually narrowing a region from an outer side) and segment forming processing (a process of approximating a continuous dot row by a line segment). Further, a similar constitution can be provided by subjecting a valley line (dot row) of a potential field disclosed in JP-A-2001-154706 to the segment forming processing. According to one embodiment, paths to the respective inlets/outlets are added to paths of moving at the center portion of the movable space 201 in the location.

The user direction and position coordinates 1002 constitute user position information according to the invention. The direction and position coordinates 1002 show the position and a direction of the user 2 in the location. Position coordinates and a direction of the user 2 on the movable space diagram 1011 are stored to the map information storing portion 108. The user direction and position coordinates are determined by relative distance and direction of the mobile robot 1 and the user 2 detected by the position direction coordinates 1004 for holding a direction and a position of the mobile robot 1, mentioned later, and the detector 104. The position coordinates and the direction on the movable space are calculated by the user position determining portion 106, discussed later.

The user present location number 1003 is a number indicating a location at which the user 2 is present. The user present location number 1003 is stored in the map information storing portion 108 as a location number. An abnormality determination reference, discussed later, is set based on the user present location number 1003. For example, when the mobile robot 1 is present at the corridor 52, and it is determined that the user 2 moves to the rest location 54, the mobile robot 1 cannot be moved to the rest location 54 since the enterable flag is “0”. The mobile robot 1 updates the user present location number 1003 to “54”, and an abnormality determination reference based thereon is set to the abnormality determination reference setting portion 102, discussed later.

The direction and position coordinates 1004 constitute current position information according to an embodiment of the invention. The direction and position coordinates 1004 represent a direction of the mobile robot 1 and a position at which the mobile robot 1 is present in the location and are stored to the map information storing portion 108 as position coordinates on the movable space diagram 1011. Further, the direction position coordinates 1004 are specified by the current position specifying portion 109 from a moving distance, a moving direction and the direction position coordinates 1004 before movement.

The current location number 1005 indicates a location in which the mobile robot is present. The current location number 1005 is stored on the map information storing portion 108 as a location number. When the mobile robot 1 is moved and is determined to pass the inlets/outlets 11 through 21, a value of the current location number 1005 is updated. Thereafter, by the movable space diagram 1011 and the movable path data 1010 in correspondence with the updated location number 1005, the mobile robot 1 specifies position coordinates of the user, predicts a moving path thereof and specifies position coordinates of the mobile robot 1.

The detector 104 is a detecting device according to one embodiment of the invention and uses an adaptive microphone array portion 501, a camera portion with zoom lens and pan head 502. The detecting direction of the adaptive microphone array portion 501 and the camera portion with location lens and pan head 502 is controlled by the detecting direction controller 105, discussed later.

An output of the adaptive microphone array portion 501 is further supplied to a specific sound detector 503, a speaker identifying portion 504 and a voice vocabulary recognizing portion 505. An output of the camera portion with location lens and pan head 502 is further supplied to a moving vector detector 506, a face detecting and face identifying portion 507 and a stereoscopic distance measuring portion 508.

The adaptive microphone array portion 501 is a device provided with a plurality of microphones for inputting only voice in a designated detecting direction by separating voice from surrounding noise.

The camera portion with zoom lens and pan head 502 is a stereoscopic camera provided with an electric zoom and an electric pan head which can be panned and tilted.

A direction of the adaptive microphone array portion 501 and zooming and panning and tilting angles (parameters determining a directionality of the camera) of the camera portion with zoom lens and pan head 502 are also controlled by the detecting direction controller 105.

The specific sound detector 503 is an acoustic signal analyzing device able to detect shortly attenuating sound, for example, the sound of cracking glass, the sound of a falling article, the sound of a closing door or the like. The specific sound detector 503 can also detect sound having a specific pattern and a variation pattern thereof of the sound of a shower, the sound of a flushing toilet, the sound of rolling toilet paper or the like. The specific sound detector receives input from the adaptive microphone array portion 501.

The speaker identifying portion 504 is a device for identifying a person from the voice of the person inputted by the adaptive microphone array portion 501. The speaker identifying portion 504 outputs a speaker ID by checking a formant (a strong frequency component in the pattern) particular to the person included in the pattern of the input voice.

The voice vocabulary recognizing portion 505 checks the pattern of the voice of the person inputted by the adaptive microphone array portion 501 to convert to a vocabulary row representing content of speech, for example, a character row or a vocabulary code row or the like to output. The formant for identifying the speaker is changed depending on the content of speech and, therefore, the speaker identifying portion 504 checks the formant by using a reference pattern in accordance with the vocabulary identified by the voice vocabulary recognizing portion 505. By the checking method, speakers having various contents of speech can be identified and as a result of identification, the speaker ID is outputted.

The moving vector detector 506 calculates a vector representing directions of movement at respective small regions in the image. The moving vector detector 506 uses an optical flow from the image input by the camera portion with zoom lens and pan head 502 to decompose the input image to regions having different movements by grouping respective flow vectors by same kinds. A relative direction of movement of the detected person relative to mobile robot 1 is calculated from the information.

The face detecting and face identifying portion 507 detects the face by checking a pattern from the image inputted by the camera portion with zoom lens and pan head 502 and identifies the person from the detected face to output the person ID.

The stereoscopic distance measuring portion 508 calculates the parallax of the eyes of each portion of the image from the stereoscopic input image of the camera portion with zoom lens and pan head 502 and measures a distance of each portion based on the principle of triangulation. A relative distance from the mobile robot 1 is calculated from a result thereof. A portion in the image constituting an object of measuring a distance is constituted by each moving region detected by the moving vector detector 506 and each face region detected by the face detecting and face identifying portion 507. As a result, a distance to the face capable of being caught visually and the three-dimensional moving vector of each moving region can also be calculated.

The user position determining portion 106 calculates coordinates and a moving direction on the movable space diagram 1011 by deriving a position and a moving direction at which the user 2 is actually present based on a determination of whether the person is the user 2 by the speaker ID or the person ID inputted from the detector 104, a relative direction and a relative distance inputted from the detector 104 and position coordinates and a direction of the mobile robot 1 by the direction position coordinates 1002 stored to the map information storing portion 108. Information of the coordinates and direction is stored to the user direction and position coordinates 1004 on the map information storing portion 108. The user position determining portion 106 reads observation evidence indicating the presence of the user 2 from input information of the detector 104.

The user moving path predicting portion 107 comprises a moving path predicting device according to the invention. The user moving path predicting portion 107 predicts a moving path of the user 2 and a range at which the user on the movable space diagram 1011 is predicted to be present. The prediction is based on the user direction and position coordinates 1002 at which the user 2 is present or the user direction and position coordinates 1002 at which the user 2 is finally detected and the movable path data 1010.

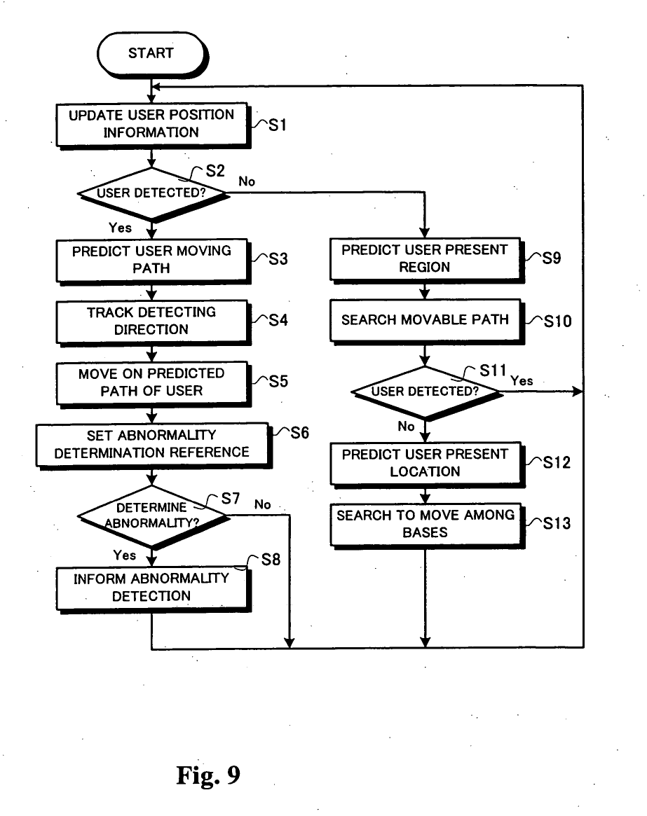

The detecting direction controller 105 is a detecting direction control device according to the invention and is used in detecting direction tracking (step S4 of FIG. 9, discussed later) carried out for searching whether the user 2 is present in a user detecting region 601 or for preventing the user 2 from being lost. According to the embodiment, the detecting direction controller 105 controls the detecting direction of the adaptive microphone array portion and controls electric zooming and panning and tilting angle of the camera portion with zoom lens and pan head 502.

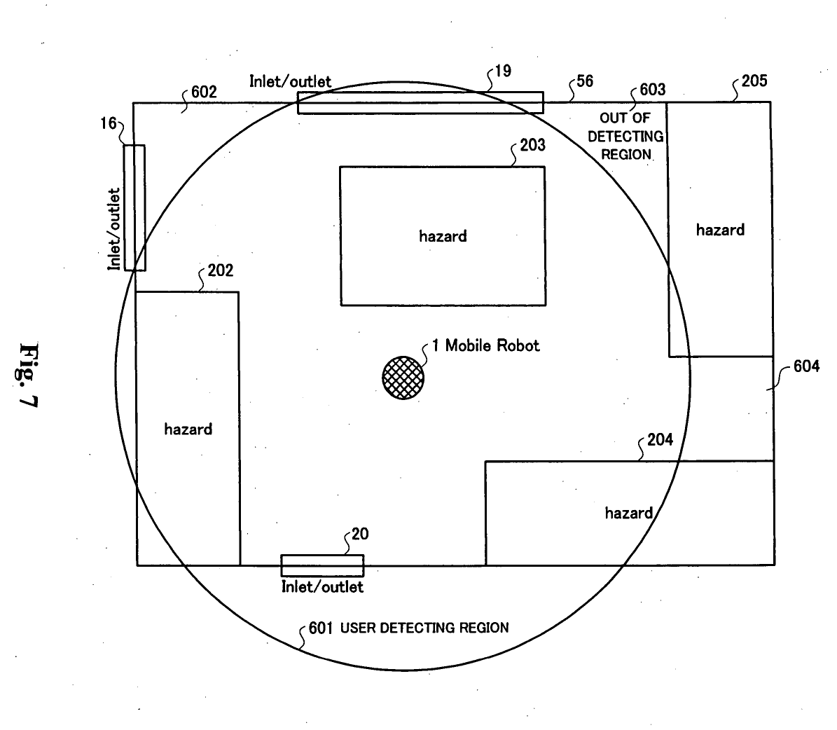

Further, naturally, there is an effective space range for a sensor provided to the detector 104. Although a width of the effective space range can be changed by a condition of an environment in which the mobile robot 1 is operated, in this case, when the detector 104 is controlled in all the orientations by the detecting direction controller 105, the effective space range is regarded to be substantially a circular region. However, other shaped regions including, but not limited to triangular, rectangular and pie-shaped regions may be used. FIG. 7 shows the user detecting region 601 capable of detecting the user 2. When the user 2 is present in the user detecting region 601, the mobile robot 1 can detect the user 2 by controlling the detector 104 with the detecting direction controller 105. In this case, spaces 602 through 604 of the movable space 201, widened to an outer side of the user detecting region 601 on the movable space diagram, are defined as outside of the detecting region. When the user 2 is present outside of the detecting region, the user 2 cannot be detected from the position of the mobile robot 1.

The user present location predicting portion 113 works as a presence base predicting device according to the invention. When the user 2 cannot be detected, the user present location prediction portion 113 predicts a location having a possibility of presence of the user thereafter by the movable location constitution data 1001 based on prediction of an inlet/outlet used for moving the user 2 by the user moving path predicting portion 107.

The path generator 112 works as a path generating device according to the invention. The path generator 112 generates tracking path information from a predicted moving path of the user 2 by the user moving path predicting portion 107 and a current position of the mobile robot 1 based on the movable path data 1010, and generates a searching path for searching the user 2 from the current position of the mobile robot 1 to the location at which the user present location predicting portion 113 predicts that there is a possibility of presence of the user 2 based on the movable location constitution data 1001, the movable path data 1010 and a robot movable space diagram 2401.

The drive portion 111 constitutes a moving device according to the invention and moves in accordance with path information generated by the path generator 112.

The moving distance and direction detector 110 acquires a distance and a direction moved by the drive portion 111. According to one embodiment, the mobile robot 1 is provided with a gyro and a pulse encoder and detects a moving direction and a moving distance of the mobile robot 1 thereby. The acquired moving direction and moving distance are output to the current position specifying portion 109, discussed later.

The current position specifying portion 109 specifies a current position of the mobile robot 1 by the moving direction and moving distance output from the moving distance and direction detector 110 and the direction and position coordinates 1004 of the mobile robot 1 before movement. The direction and position coordinates 1004 on the map information storing portion 108 are updated by the specified direction in which the mobile robot 1 is directed and the coordinates indicating the specified current position. Further, when determined to move to a new location, the current location number 1005 of the map information storing portion 108 is updated by a location number indicating the location after movement.

The abnormality determination reference setting portion 102 works as an abnormality determination reference setting device according to one embodiment of the invention to set a reference of detecting an abnormality in accordance with a location at which the user 2 is present. In other words, the mobile robot can detect an abnormality that relates to the location of the user (a condition regarded as abnormal in one location may not necessarily be regarded as abnormal in another location). The abnormality determination reference setting portion 102 does not only set a method of determining an abnormality by the location at which the mobile robot 1 is present but may also set the method of determining the abnormality by the location at which the user 2 is present.

As an example of a reference of detecting an abnormality, in the case in which the user 2 is present at the rest location 54, when the user 2 is safe, sound of rolling toilet paper or sound of flushing water is to be heard over the door. The sound is referred to as “action sign” of the user 2 to constitute a sign indicating that the user 2 is acting safely without abnormality. The mobile robot 1 cannot enter the rest location 54 since the enterable flag 402 is “0” and therefore, the mobile robot 1 monitors such an action sign from the enterable corridor 52 contiguous thereto. Naturally, even when the mobile robot 1 is present at the corridor 52 similarly, in the case in which the user 2 is assumedly present at a base to which the mobile robot 1 is not movable, the mobile robot 1 monitors a different action sign. Thus, one of the characteristics detected by a sensor on the mobile robot may be sounds created by the user 2, or the time between the creation of sounds.

Further, in the case in which the user 2 is present at, for example, the bath location 58, when the user 2 is safe, the interrupted sound of a shower is naturally to be heard over the door. The mobile robot 1 cannot enter the bath location 58 similar to the rest location 54 and therefore, the mobile robot 1 monitors the interrupted shower sound (a change in an intensity of sound of a jet stream impinging on an article emitted when moving the shower) or sound of water of a bathtub as an action sign from the enterable wash location 57 contiguous thereto. When the shower sound is interrupted, the shower sound constitutes evidence that the user 2 is moving in the shower. Further, when the shower sound is heard for a long period of time without interruption, the shower sound may be evidence indicating a possibility that the user 2 is fallen while in the shower.

Further, another action sign includes also a voice of the user 2. The action signs are detected by the detector 104.

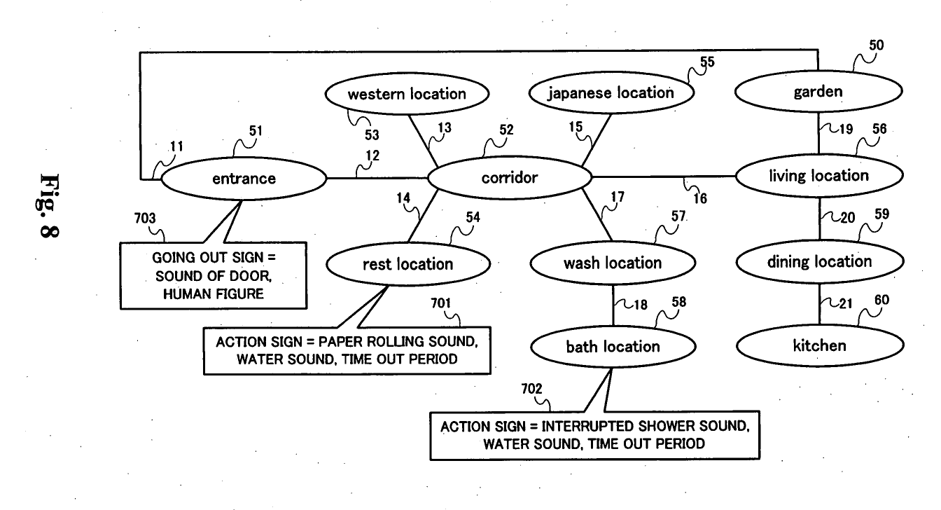

According to one embodiment, the reference of determining the abnormality is constituted by the action sign emitted from the location where the user 2 is present. Abnormality detection reference information of action signs is held in the respective location information of the movable location constitution data 1001. FIG. 8 illustrates the movable location constitution data holding the abnormality detection reference information. Further, the movable location constitution data holds all the information with regard to a going out sign in the location information indicating a location from which the user can go out. The going out sign refers to a sign for determining whether the user 2 has left the house. The going out sign indicates that the user 2 left from an inlet/outlet communicating with the outdoors and indicating a situation in which the user 2 is actually lost over the inlet/outlet communicating with outdoors, or the user 2 cannot be detected at a vicinity of the entrance 51 for a predetermined period of time after detecting the sound of opening and closing the door of the entrance 11.

Further, when the user present location number 1003 is updated, the abnormality determination reference setting portion 102 sets the abnormality determination reference.

The abnormality determining portion 103 works as an abnormality determining device according to one embodiment of the invention and determines an abnormality by comparing an action sign detected by the detecting device with the abnormality determination reference set by the abnormality determination reference setting portion 102. When an abnormality is determined, the abnormality is output to the abnormality detection informing portion 101.

The abnormality determining portion 103 determines that an abnormality is affecting the user 2 when an action sign is not observed after the user 2 enters a location, when a next action sign is not observed until elapse of a predetermined time period since the last action sign was observed and when the user 2 has not moved after a final action sign has been observed.

Further, the abnormality determining portion 103 determines whether the user 2 has left via the going out sign. As a method of calculation when the going out sign is detected by the detecting device, mobile robot may make a calculation in which the abnormality determining portion 103 is at standby until the user 2 enters in from the entrance 51, a calculation in which the abnormality determining portion 103 is at standby by whether the user 2 enters the house from the garden 50 after temporarily moving to the living location 56, or a calculation in which the abnormality determining portion 103 is at standby at the entrance 51 after it is determined that the user 2 does not enter the house from the garden 50. In this case, the abnormality is not detected by the action sign because the robot concludes that the user 2 has left. Further, the mobile robot 1 starts to act when the mobile robot 1 detects that the user 2 enters in from the entrance, or when an action sign of detecting sound of opening the door of the inlet/outlet 19 of the living location 56 is observed.

When determination of the abnormality is inputted from the abnormality determining portion 103, the abnormality detection informing portion 101 informs a monitor center. According to one embodiment, informing (reporting) is carried out by using a public network by a portable telephone. In yet another embodiment, the mobile robot is able to warn the surrounding area by sounding an alarm.

With regard to the following flowcharts, the architecture, functionality and operation may be performed out of order or concurrently.

Next, an explanation will be given of the processing by the mobile robot 1 according to the embodiment as described above. FIG. 9 is a flowchart showing a procedure of a total processing of the mobile robot 1 according to the embodiment.

The user position determining portion 106 reads an observational evidence indicating presence of the user 2 from information input by the detector 104 and calculates position coordinates of the movable space diagram 1011 at which the user 2 is present from the direction and position coordinates 1004 of the mobile robot 1 and relative orientation and distance of the user 2 relative to the mobile robot 1 (step S1 of FIG. 2). The observational evidence indicating presence of the user 2 is defined as “user reaction”.

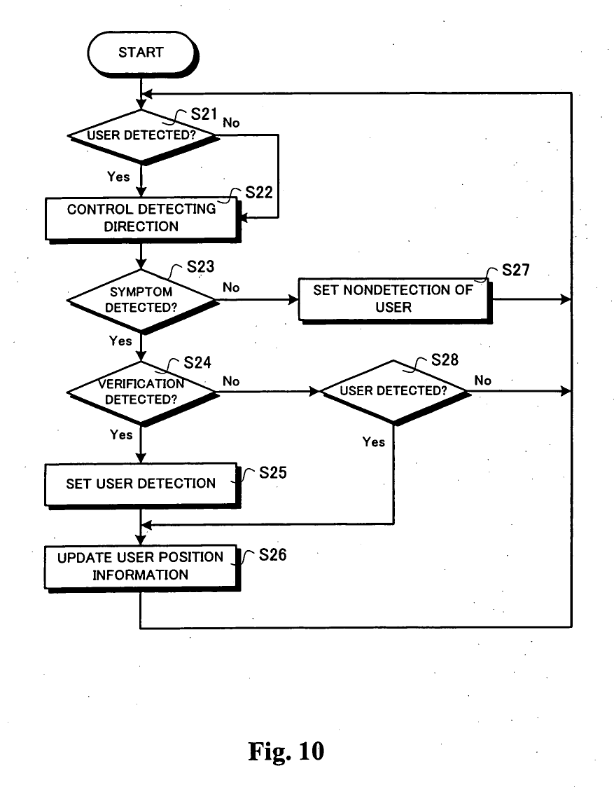

FIG. 10 shows a detailed flowchart of step S1 of FIG. 9 and shows processing comprising: a user detection determination processing step S21, a detecting direction control step S22, a symptom detection determination processing step S23, a verification detection determination processing step S24, a user detection setting processing step S25, a user position information updating processing step S26, a user nondetection setting processing step S27 and a user detection determination processing step S28.

At the user detection determination processing step S21, the user position determining portion 106 investigates the user detection flag indicating whether the user 2 is detected. When the user detection is set by the user detection flag, the operation branches to the right and branches downward otherwise.

The case of branching downward from step S21 indicates a line of processing used when the user 2 is not detected at the detection direction control processing step S22, and the detecting direction controller 105 makes the detector 104 search all over the user detecting region 601 or carries out the control until detecting the user 2.

When branched to the right from step S21 or after the processing of step S22, at the symptom detection determination processing step S23, the detector 104 verifies presence or absence of the symptom indicating presence of the user 2 regardless of detection or nondetection of the user 2. The symptom indicating presence of the user 2 refers to an output of the vocabulary code by the voice vocabulary recognizing portion 505, an output of moving region information by the moving vector detector 506, or an output of face detection information by the face detecting and face identifying portion 507. According to the processing step, when the symptom is detected, the operation is branched downward and branched to the right otherwise. When following branches to the right through the user nondetection setting step S27, the user position determining portion 106 determines that the symptom of the user is lost and sets the user detection flag to the user nondetection by the user nondetection setting processing step 27.

At the verification detection determination processing step S24, the user position determining portion 106 verifies evidence of whether the user is a regular user. The evidence of the regular user refers to an output of the speaker ID indicating the user 2 by the speaker identifying portion 504, or an output of the person ID indicating the user 2 by the face detecting and face identifying portion 507. At the processing step, when the verification is detected, the operation is branched downward and branched to the right otherwise. When branched to the right, there is brought about a state in which the verification is lost although the symptom of the user 2 is detected.

When branched to the right at step S24, at the user detection determination processing S28, the user position determining portion 106 determines whether the user is detected or not detected from the user detection flag. When the user detection flag is set to detect the user, the regular user is regarded to detect only by the detected symptom.

When branched downward at step S24, at the user detection processing step S25, the user position determining portion 106 sets the user detection flag to the user detection such that verification of the regular user is detected.

After the processing of step S25 or when branched downward at step S28, at the user presence information updating processing step S26, when verification or a symptom of the user 2 is detected, the user position determining portion 106 calculates relative orientation and relative distance relative to a gravitational center of a moving region recognized as the regular user; and an absolute position on the movable space diagram 1011 stored to the map information storing portion 108 is calculated by constituting a reference by the direction and position coordinates of the mobile robot 1 by the direction and position coordinates 1004 to constitute user position information. The user position information is stored to the map information storing portion 108 as the user direction and position coordinates 1002. That is, a process of continuing to update the user position information allows the robot to react to changes in the user's position.

Referring back to FIG. 9, after the user position information updating step S1, it is determined whether the user 2 is detected at step S1 (step S2). When the user 2 is detected, the moving path is predicted by the direction and position coordinates of the user 2 stored to the user direction and position coordinates 1002 updated by step S1 and the movable path data 1010 (step S3 of FIG. 2).

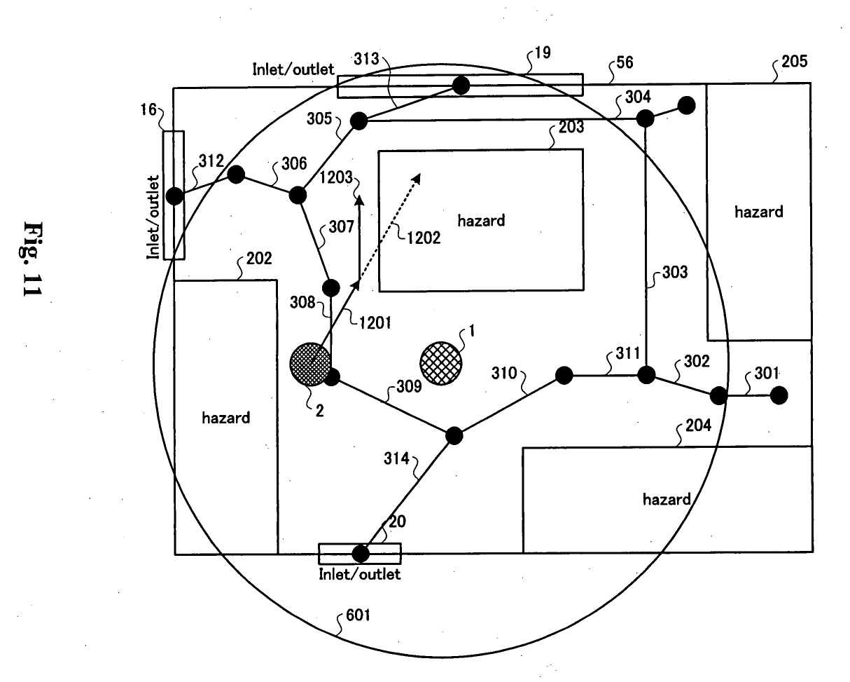

FIG. 11 shows details of a method of predicting the moving path of the user 2 by the mobile robot 1. The mobile robot 1 and the user 2 are present at illustrated positions, particularly, the user 2 is present in the user detecting region 601. Further, it is assumed that the user 2 is moved in a direction of an arrow mark 1201 by the detector 104 of the mobile robot 1. When it is assumed that the user 2 continues to move as it is, the user 2 is moved in the direction of the arrow mark 1201. However, actually, it is predicted that the user 2 turns to a direction of an arrow mark 1203 along the segment 308 on the movable path data 1010g owing to the hazard 203. In order to carry out the prediction by the mobile robot 1, the user moving path predicting portion 107 calculates a segment end point of the movable path data 1010g mostly proximate to an advancing path in the current direction of the arrow mark 1201 of the user 2 and extracts all the segment (307 and 309) connected thereto. Next, each segment extracted as a vector constituting a starting point by the above-mentioned end point and constituting an end point by other end point is caught, and there is selected a segment having a largest cosine between the segment and an advancing path in the current direction of the arrow mark 1201 of the user 2 (which is a vector) (cos θ=(v1·v2)/(|v1||v2|), v1: vector of arrow mark 1201, v2: each segment vector) (a vector direction of which is mostly similar). According to the example, the segment 308 is selected. The mobile robot 1 determines that the predicted advancing path of the user 2 is in the direction from the segment 308 to the segment 307 thereby.

Referring back to FIG. 9, after the user movement predication path step S3, the mobile robot 1 tracks the detecting direction continuing to observe the user 2 by controlling the detecting direction of the adaptive microphone array portion 501 of the detector 104 and the camera portion with zoom lens and pan head 502 by the detecting direction controller 105 along the path predicted so as not to lose sight of the user 2 (step S4). Further, the mobile robot 1 forms a tracking path for tracking the user 2 in accordance with the position coordinates based on the direction and position coordinates 1004 of the mobile robot 1, the position coordinates of the user 2 by the user direction and position coordinates 1002 and the predicted path of the user 2 from the predicted moving path of the user 2 from step S3 and tracks the user 2 by tracing the tracking path (step S5).

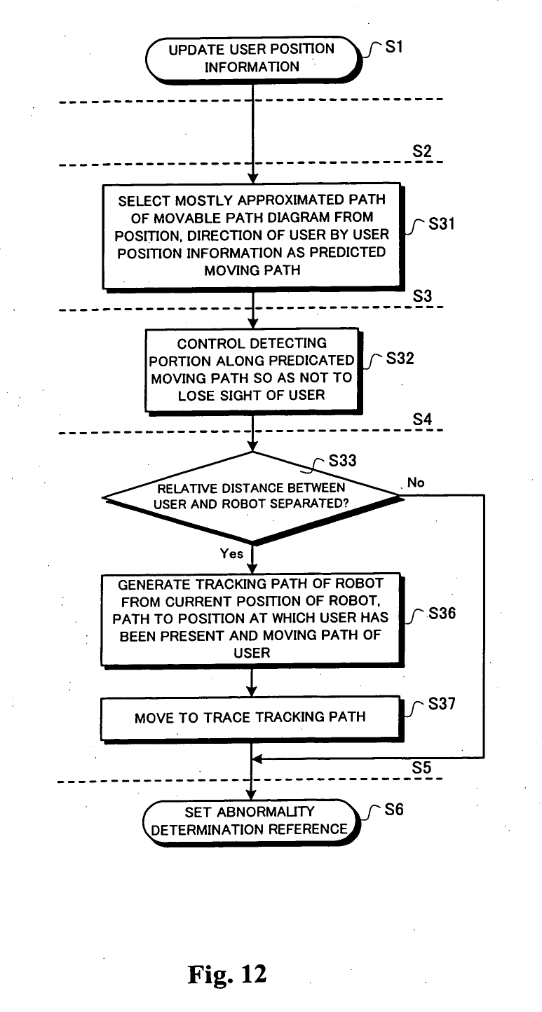

FIG. 12 shows the processing of step S3 through step S5 by the flowchart. The mobile robot 1 makes the predicted moving path of moving the user 2 by the mostly approximated path of the movable path data 1010g from the position and the direction of the user 2 by the user position information acquired by S1 (step S31), and in order not to lose sight of the user, the mobile robot 1 controls the detector 104 by the detecting direction controller 105 to be directed along the predicted moving path (step S32). Further, the mobile robot 1 continues to detect the user 2 with the detector 104 so as not to lose sight of the user 2 and determines whether a relative distance between the mobile robot 1 and the user 2 is separated from the coordinates information of the mobile robot 1 and the user 2 of the movable space diagram 1011g (step S33), and when determined that the distance is separated, the mobile robot 1 generates a tracking path for tracking the user 2 to a position where the user 2 has been present from the current position of the mobile robot 1 and the predicted moving path of the user 2 (step S36). The mobile robot 1 then tracks the user 2 by tracing the tracking path (step S37). When the mobile robot 1 and the user 2 are in the same location, the mobile robot does not change the abnormality determination reference (step S6 of FIG. 9).

Referring back to FIG. 9, when presence of the user 2 is grasped as a result of tracking in the detecting direction and moving on the predicted path of the user, the mobile robot 1 sets the abnormality determination reference in accordance with the location at which the user 2 is present according to the abnormality determination reference setting portion 102 (step S6) to detect abnormality by a monitoring method in accordance with the abnormality determination reference. Further, the abnormality determining portion 103 determines that an abnormality is brought about at the user 2 when an action sign is not observed since the user 2 has entered the location, when a next action sign is not observed until elapse of a predetermined time period since an action sign has been observed, or when the user 2 does not move after observing a final action sign (step S7). Then the abnormality detection informing portion 101 deals therewith to inform a monitor center (step S8 of FIG. 2).

When the user 2 cannot be detected at step S1 (right branch of step S2), the user moving path predicting portion 107 and the user present location predicting portion 113 predict a location where the user 2 is present from position coordinates where the user 2 is present and a moving direction (user disappearing direction) which are stored to the finally (last) detected user direction and position coordinates 1002 (step S9 of FIG. 2). The location is referred to as “user existable region”. There are two kinds of the user exitable regions, a “geometrical user existable region” on the movable space diagram 1011 predicted by the user moving path predicting portion 107 and a “phase-wise user existable region” on the movable location constitution data 1001 predicted by the user existing location predicting portion 113.

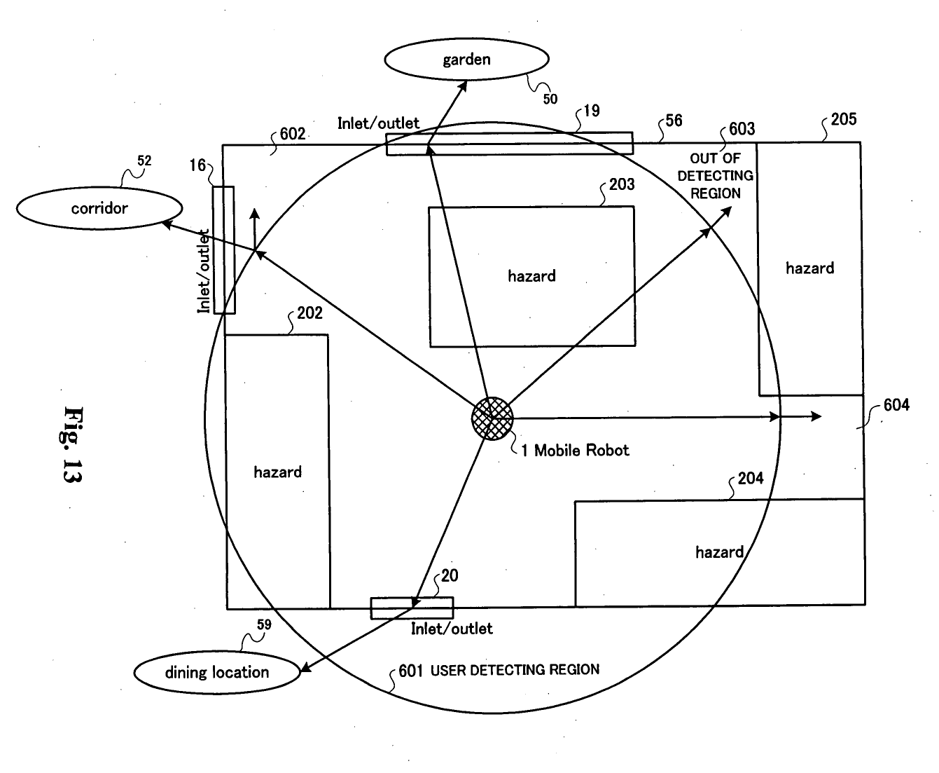

FIG. 13 exemplifies a method of predicting the location where the user is present. In the drawing, spaces out of the user detecting region 601 on the movable space diagram 1011, that is, out of detecting regions 602 through 604 can be the geometrical user existable region. Further, compartments on the movable location constitution data 1001 communicated frontward from the inlet/outlet 16 present in the geometrical user existable region and frontward from the inlets/outlets 19, 20 within the user detecting region and in the direction in which the user reaction disappears which can be the phase-wise user existable region are the garden 50, the corridor 52 and the dining location 59.

When the finally detected user disappearing direction is a direction of an arrow mark 1301 or 1302, the user existable region becomes only the outside of detecting region 604 or 603 on the movable space diagram, the locations are not provided with inlets/outlets and therefore, the user movable path predicting portion 107 determines that there is an extremely high possibility that the user 2 is present at outside of detecting region 604 or 603.

Further, when the finally detected user disappearing direction is a direction of an arrow mark 1303 or 1304, the user existable region becomes only the garden 50 or the dining location 59 on the movable location constitution data 1001 by way of the inlet/outlet 19 or 20 and the user moving path predicting portion 107 determines that there is an extremely high possibility that the user 2 has moved to the garden 50 or the dining location 59.

Meanwhile, when the finally (last) detected user disappearing direction is a direction of an arrow mark 1304, the user moving path predicting portion 107 predicts that the user 2 is present at either the outside of detecting region 602 or the corridor 52 by way of the inlet/outlet 16 which constitute the user existable region.

In this way, the geometrical user existable region shows a location having a high possibility that the lost user 2 is present on the movable space diagram 1011 and the phase-wise user existable region specifies a compartment having a high possibility that the lost user 2 has moved from the movable space diagram 1011 from the movable constitution data 1001. The information is used in searching the user 2 by the movable robot 1 when the user 2 is not present in the user detecting region.

Referring back to FIG. 9, the mobile robot 1 is moved to include the geometrical user existable region having high possibility that the user 2 is present in the user detecting region 601 and confirms whether the user 2 is present (step S10).

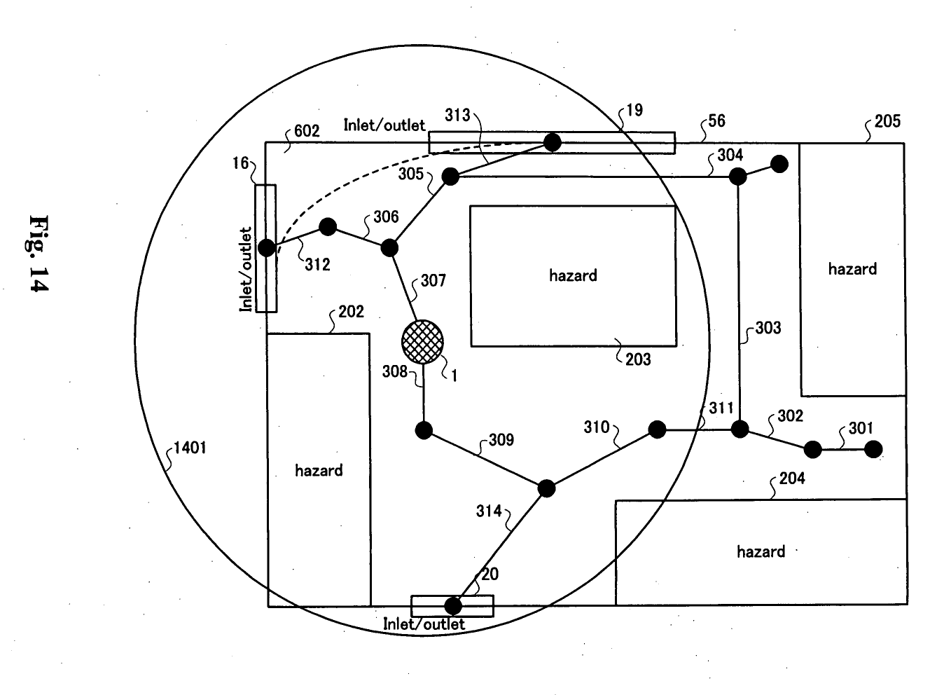

FIG. 14 exemplifies a case after the mobile robot 1 in FIG. 13 has moved to include the geometrical user existable region 602 having the high possibility that the user 2 is present to the user detectable region 601. When at first, the mobile robot 1 is present at a position shown by FIG. 13 and the finally detected user disappearing direction is directed to the inlet/outlet 16 as shown by FIG. 14, the mobile robot 1 advances in the direction of the inlet/outlet 16 on a path tracing the segments 309, 308, 307 on the movable path data 1010g, includes the geometrical user existable region 602 of FIG. 13 in the user detecting region 1401 and confirms whether the user 2 is present in the space.

Referring back to FIG. 9, when the user 2 is detected in the geometrical user existable region 602, the mobile robot 1 restarts to track the user (right branch of step S11). When the user 2 is not detected in the geometrical user exitable region 602 (downward branch of step S11), the user 2 is likely to have moved to the corridor 52 contiguous to the living location 56 by passing the inlet/outlet 16 or a space further frontward therefrom. In this case, the user present location predicting portion 113 calculates an expected value indicating expectation that the user 2 seems to be present, that is, “user presence expected value” for respective locations frontward from the corridor 52 in accordance with an elapse time period since the mobile robot 1 lost sight of the user 2 (step S12).

The user presence expected value is a value quantifying an expectation degree indicating a possibility that the user 2 has moved to respective locations to which the user 2 may move according to the movable location constitution data 1001 after the user 2 has retreated from the location (starting location).

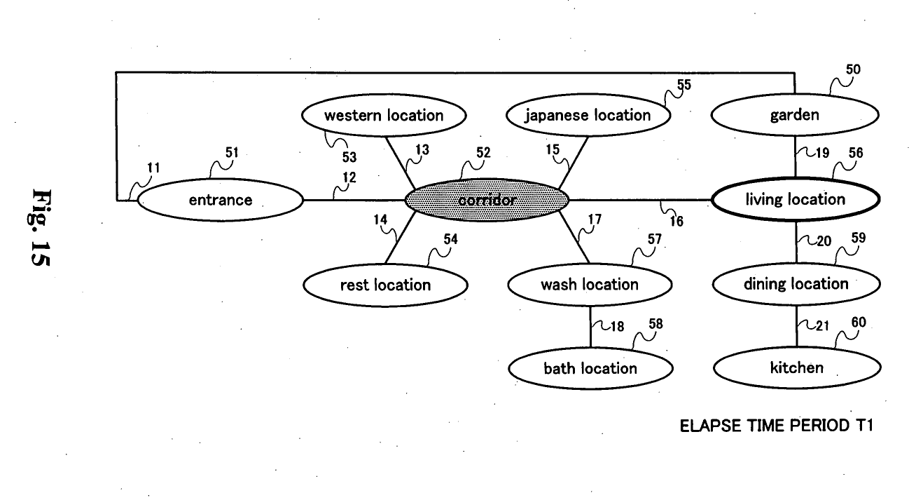

FIGS. 15, 16 and 17 schematically show a change in the user presence expected value for respective locations by paying attention to the elapse time since the mobile robot 1 lost sight of the user 2 and constitutions of the locations. In the respective drawings, the darker the netting, the higher the presence expected value is shown.

FIG. 15 is a drawing indicating a distribution of the user presence expected value when the elapse time period since the user 2 was lost is short (elapse time period is designated by notation T1). As shown by the drawing, when the elapse time period is short, a possibility that the user 2 has moved to a remote location is low and a possibility that the user 2 is present at the corridor 52 is extremely high.

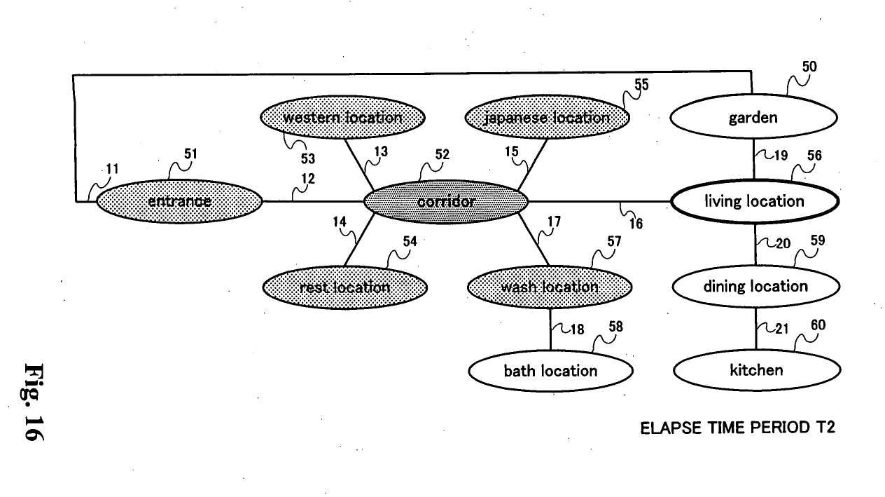

FIG. 16 is a diagram showing a distribution of the user presence expected value when the elapse time period since the user 2 was lost is of an intermediate degree (elapse time period is designated by notation T2). As shown by the drawing, when more time has elapsed than the amount of time T1, there is also a possibility that the user 2 is present at the entrance 51, the western location 53, the rest location 54, the Japanese location 55 and the wash location 57 contiguous to the corridor 52.

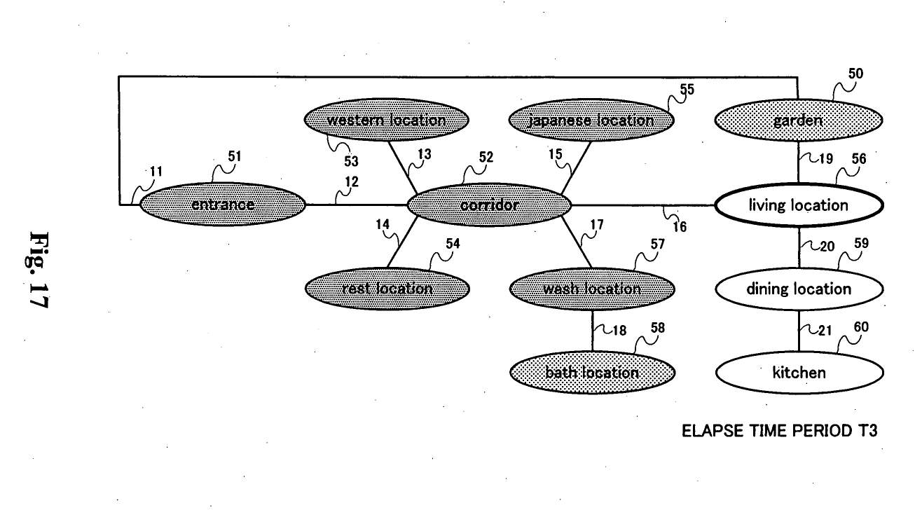

FIG. 17 is a drawing showing a distribution of the user presence expected value when the elapse time period since the user 2 was lost is long (elapse time period is designated by notation T3). As shown by the drawing, when more time has elapsed than the amount T2, there is a possibility that the user 2 is moved to the garden 50 by going out from the entrance 51 and the bath location 58 frontward from the wash location 57.

According to the above-described user presence expected value, user presence expected values can be calculated for respective locations uniformly based on constitutions of the locations without taking geometrical shapes of the respective locations into consideration. However, actually, when the user 2 is moved from a certain location to another location, the moving path differs for respective locations of destinations by the geometrical shapes of the locations and therefore, the moving distance differs by the locations of the destinations. Further, there is a limit in a moving speed of the user 2 and therefore, the user presence expected value differs for respective locations even when the locations are locations to which the user 2 is movable (may access) from the same location because of a difference in the moving distance. Hence, a method of calculating the user presence expected value taking into consideration the geometrical shapes of the respective locations by the user present location predicting portion 113 will be shown below.

First, the user present location predicting portion 113 calculates a distance between an outlet of a starting location and an inlet to other location to which the user 2 may move via the outlet by summing up distances of moving the user 2 to respective locations detoured up to the inlet. For example, when the user 2 moves from the living location 56 to the bath location 58, it is determined that the user 2 moved to the bath location 58 by way of the corridor 52 and the wash location 57 by the movable location constitution data 1001. The user moving distance in the detoured wash location 57 is a moving distance from the inlet/outlet 17 connecting the corridor 52 and the wash location 57 to the inlet/outlet 18 connecting the wash location 57 and the bath location 58. The distance can be calculated as a length of a shortest path connecting the inlet/outlet 17 and the inlet/outlet 18 of the wash location 57 on the movable path data 1010.

When the user 2 is assumed to move at a constant moving speed, a moving distance of the user 2 is proportional to an elapse time period and a reachable location. Actually, there is a variation in the moving speed of the user 2. Therefore, a distribution of a certain expected value is indicated in a distance of moving the user 2 within a constant time period.

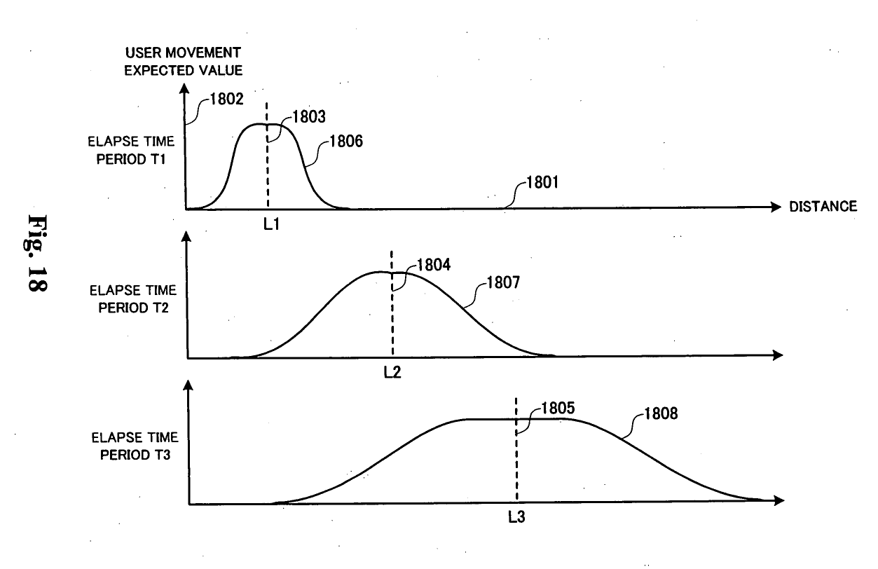

FIG. 18 schematically shows the distribution. In the drawing, the abscissa 1801 indicates an axis indicating a distance and the coordinates 1802 is an axis of an expected value representing a probability that the user 2 reaches a certain distance. The drawing shows a procedure in which, with an increase in the elapse time period to T1, T2, T3, a distance indicating a maximum value of the expected value is increased to L1, L2, L3; and curves representing the expected values in the forms of expected value distributions of the user moving distances (user movement expected values) become gradual owing to the dispersion in the moving speed as 1806, 1807, 1809. Further, in the drawing, a shape of a distribution of a probability of the user movement distance is modeled by a normal distribution.

FIG. 20 schematically shows a change in expected values of respective locations in accordance with an elapse time period since the mobile robot 1 lost sight of the user 2 when the user presence expected value is calculated in consideration of the geometrical shape of the location. Similar to the above-described drawings, the darker the netting, the higher the presence expected value is shown. In the drawing, since a moving distance from the corridor 52 to the Japanese location 55 or the wash location 57 is short, the user presence expected value is high. On the other hand, since a moving distance of the corridor 52 to the entrance 51 is long, the user presence expected value is low. Further, since the wash location 57 is narrow, a path of moving to the bath location 58 is also short, there is brought about a possibility that the user 2 has moved to the bath location and therefore, the user presence expected valued is calculated also with regard to the bath location 58.

FIG. 18 shows a region on the distance axis before the maximum point 1805 indicating a maximum value of the user presence expected value with an elapse of time, for example, at elapse time T3. The region corresponds to a distance shorter than L3 in the drawing and indicates a distance having a possibility that the user 2 is present. Therefore, at the distance shorter than the L3, an expected value of the maximum point 1805 is given as the user presence expected value.

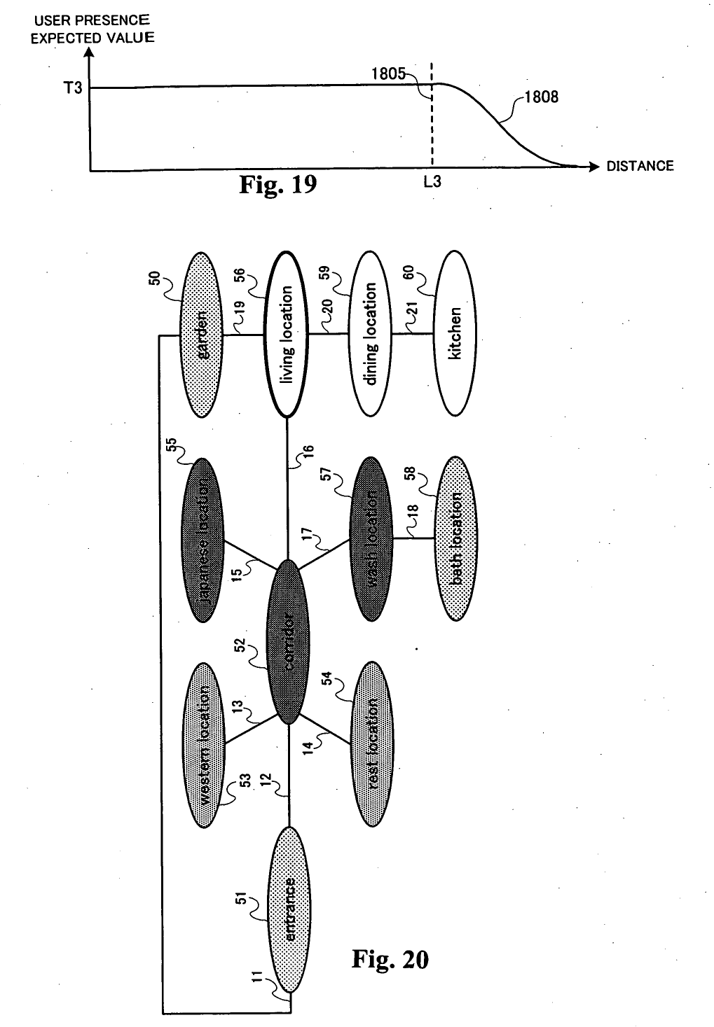

On the other hand, the user movement expected value per se is given to a region on the distance axis which does not pass the maximum point 1805, that is, a distance longer than the maximum point L3 as the user presence expected value. As a result, the user presence expected value at the elapse time T3 is as shown by FIG. 19.

An elapse time period is measured by constituting an onset at the time at which the mobile robot 1 last detected the user 2 in the direction of the inlet/outlet, until the mobile robot 1 catches the user 2 within the user detecting region 601 by following the user 2, the user presence possibility in accordance with the elapse time period is calculated as a function of the distance as described above, and the user presence possibility of the elapse time period in accordance with a distance from starting location to each location is given to each location as the user presence expected value.

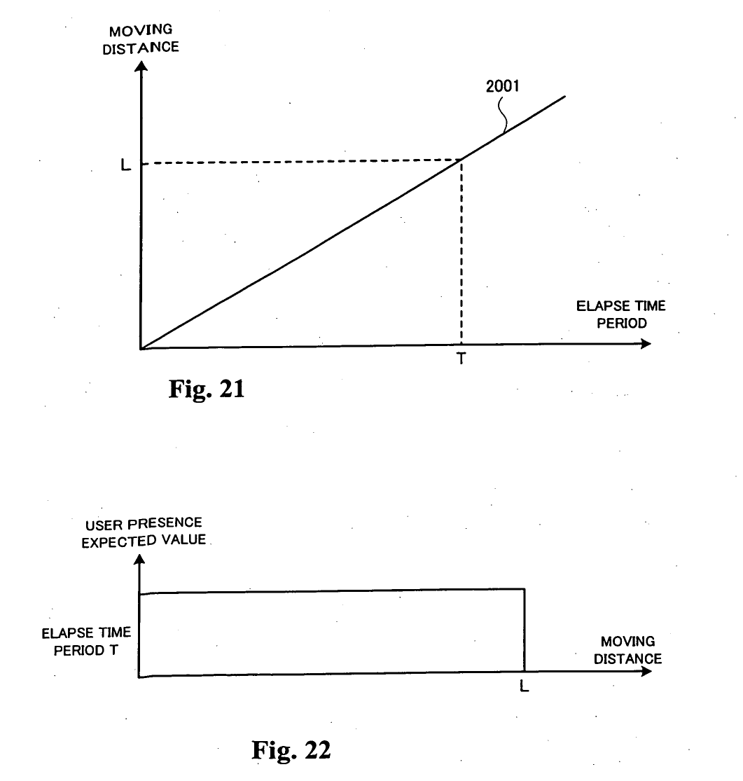

Further, FIG. 21 shows a relationship between an elapse time period and a maximum user moving distance when a maximum value of a user moving speed is assumed not to exceed a certain value in order to calculate the user presence expected value further. The maximum value of the user moving distance (maximum user moving distance) becomes a straight line 2001 in proportion to the elapse time period as shown by FIG. 21. A maximum user moving distance L at an arbitrary elapse time period T is derived from the straight line 2001 of the drawing and when the elapse time period is T, the user 2 is predicted to be present within a range of 0 through L. FIG. 22 shows the user presence expected value in this case. As shown by FIG. 22, the user presence expected value becomes a constant positive value on a left side of the distance L and becomes a rectangular shape.

Referring back to FIG. 9, the user present location predicting portion 113 starts action of searching the user 2 by moving in an order of locations having higher user presence expected values in the case in which there is not an anticipated geometrical user existable region, or even in the case in which the geometrical user existable region is present, when the user 2 cannot be detected in the geometrical user existable region (step S13). With regard to a path riding over locations, a path is generated generally on the movable location constitution data 1001, in respective locations, local paths connecting passable inlets/outlets are generated on the movable path data 1010 to achieve the movement.

Further, when the mobile robot 1 detects, for example, the sound of the flushing toilet and the sound of the shower by the detector 104 in searching where to move, the rest location 54 or the bath location 58 which are proper as a locations of emitting these detected sounds and are predicted as locations where the user 2 may be present. The locations are set to be targets of movement and it is not necessary to search other locations. Further, when, for example, the sound of opening and closing the door is detected by the detector 104, in an advancing direction in searching to move, it is not necessary to search a location other than one in the direction of the detected sound. When the location where the user 2 is present is predicted in this way, the mobile robot 1 sets a location which is enterable and having a path to reach the location and a location mostly proximate to a location where the user is present (including a location where the user 2 is present) as a location of an object of movement.

The mobile robot 1 according to the embodiment enables the robot to search for the user 2 efficiently and in a wide range based on the existable region of the user 2 of the movable path data 1010 and the movable location constitution data 1001 for carrying out two kinds of searching operation of searching movement of the user 2, one in the geometrical range and the other searching movement of the user 2 in the phase-wise region.

The mobile robot 1 according to the embodiment prevents loss of sight of the user 2 by controlling the detecting direction of the detecting device in accordance with the path on which the user 2 is predicted to move.

Further, the mobile robot 1 according to one embodiment can track where to move without losing sight of the user 2 by generating the tracking path from the current position and the direction of the user 2 and the movable path information. The mobile robot 1 then follows the tracking path. Further, even in the case of losing sight of the user 2, the user 2 can be searched efficiently by predicting the moving path from the last detected location of the user 2.

The mobile robot 1 according to one embodiment is capable of adaptively detecting an abnormality by a base where the user 2 is present since operation of detecting the abnormality of the user 2 is carried out based on presence of the user 2 on the movable base constitution information.

The mobile robot 1 according to one embodiment is able to search for the user 2 efficiently by calculating the expected values where the user 2 may be present for the respective locations of destinations and the locations to which the user 2 is movable. Further, the mobile robot 1 is able to search for the user 2 further efficiently by pertinently calculating the user presence expected values from differences in moving distances based on differences in the geometrical shapes of the respective locations.

Further, according to the embodiment, the adaptive microphone array portion 501 may be able to specify the detecting direction and is not restricted to input only sound in the detecting direction. As a detecting direction control device, it is possible to control the detecting direction by operating a main body of the mobile robot 1 other than the detecting direction control portion. Although the current position specifying portion 109 acquires the current position by using a gyro and a pulse encoder, a method of specifying the current position by ultrasonic wave or the like is also conceivable.

### Second Embodiment

The first embodiment is an example of applying the invention when a movable space of the mobile robot 1 and a movable space of the user 2 coincide with each other. However, in an actual environment, there may be present objects having a height over which the mobile robot 1 cannot pass but the user 2 can tread across. There also may be objects under which the mobile robot 1 can pass, but the user 2 normally moves around. Therefore, the mobile robot 1 according to the second embodiment generates a detour path around a hazard when there is a path on which the mobile robot 1 cannot move although the path is a movable path for the user 2.

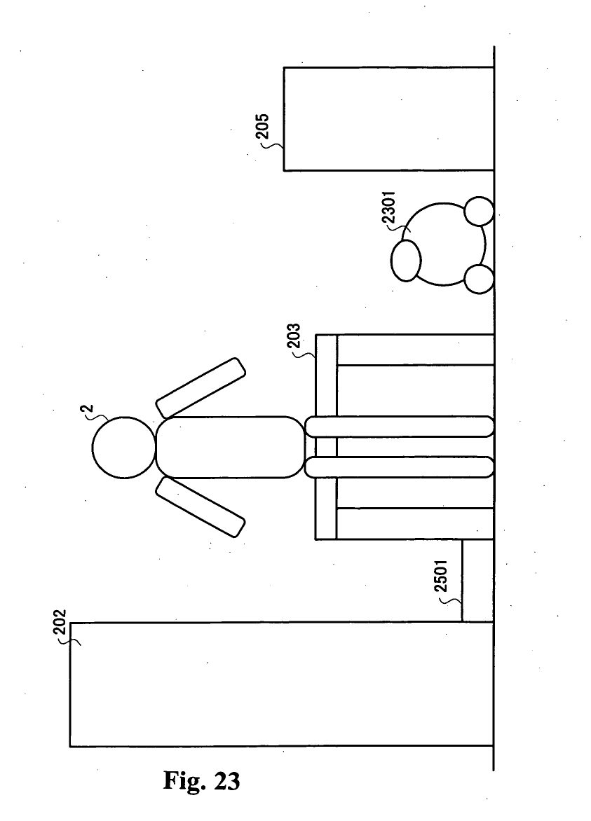

FIG. 23 shows a situation according to the embodiment. Numerals 202, 203, 205 in the drawing designate hazards the same as those illustrated in FIG. 4 in the first embodiment. According to the embodiment, a cushion 2501 is further added on a floor.

In this case, although the cushion 2501 does not constitute a hazard to the user since the user 2 can tread thereover, a top plate of the table 203 constitutes a hazard to the user 2. On the other hand, although the cushion 2501 and legs of the table 203 constitute hazards to a mobile robot 2301, the top plate of the table does not constitute a hazard for the mobile robot 2301 since the mobile robot 2301 can pass thereunder. In such a state, when the mobile robot 2301 can utilize a shortcut course which is more efficient than in following the path of the user by going under the table, convenience thereof is to be promoted further.

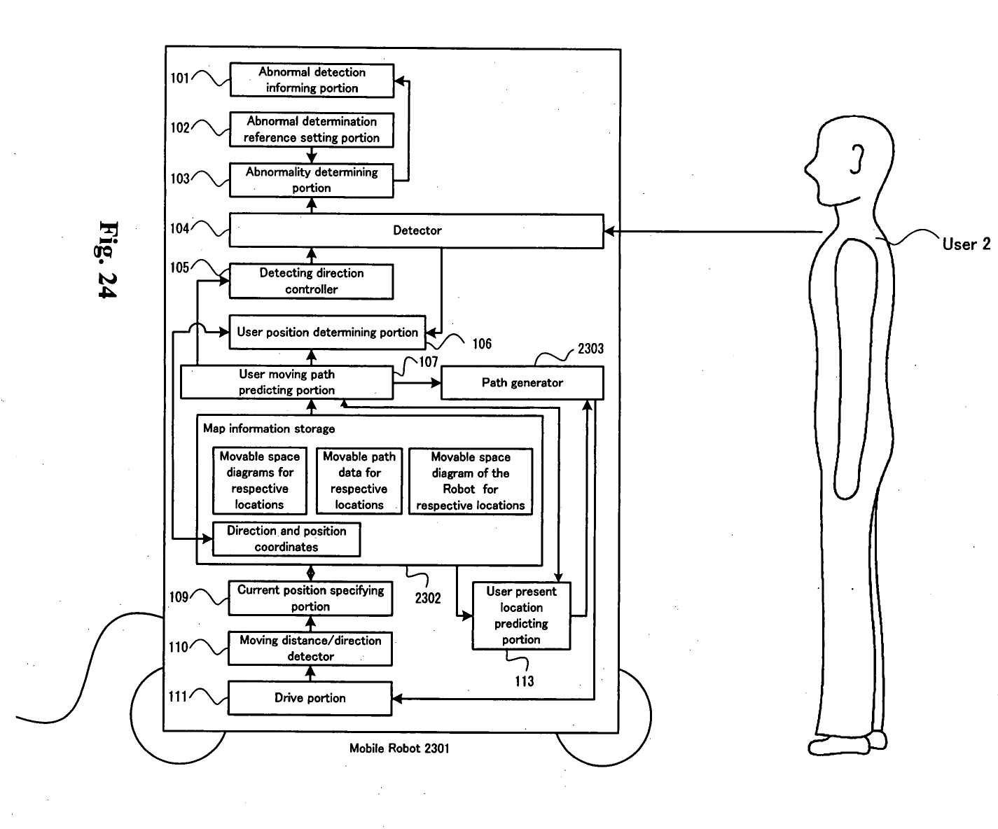

FIG. 24 is a block diagram showing the main functioning elements of the mobile robot 2301 according to the second embodiment of the invention. There is constructed a portion in which the map information storing portion 108 in FIG. 1 of the above-described first embodiment is changed to a map information storing portion 2302 having storing information different from that of the map information storing information 108 and the path generating portion 112 is changed to a path generator 2303 having a processing different from that of the path generator 112. In the following explanation, constituent elements the same as those of the above-described embodiment 1 are attached with the same notations and an explanation thereof will be omitted.

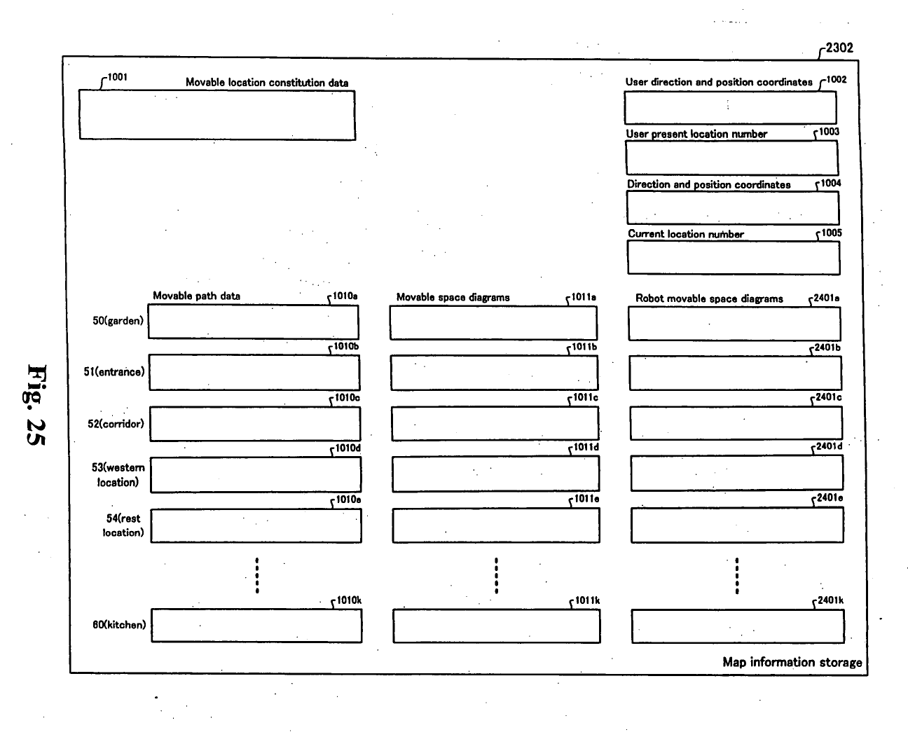

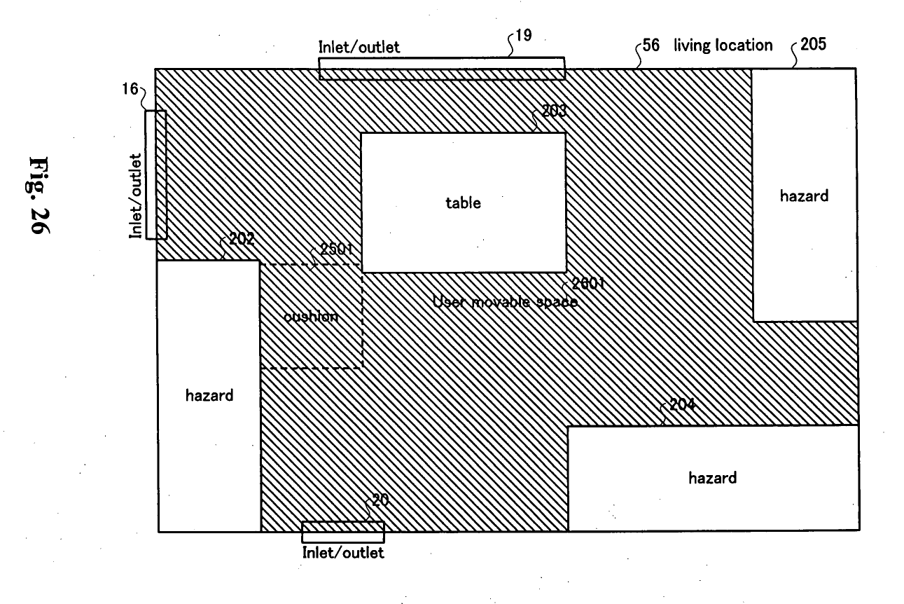

The map information storing portion 2302 is a storage device according to the invention and stores constitution diagrams of locations, map information of respective locations, information of current locations of the mobile robot 2301 and the user 2. FIG. 25 shows information held by the map information storing portion 2302 according to the embodiment. The map information storing portion 108 is stored with the movable location constitution data 1001, the movable space diagrams 1011a through k and the movable path data 1010a through k of respective locations, the user direction and position coordinates 1002, the user present location number 1003, the direction and position coordinates 1004, the current location number 1005 as well as robot movable space diagrams 2401a through k.

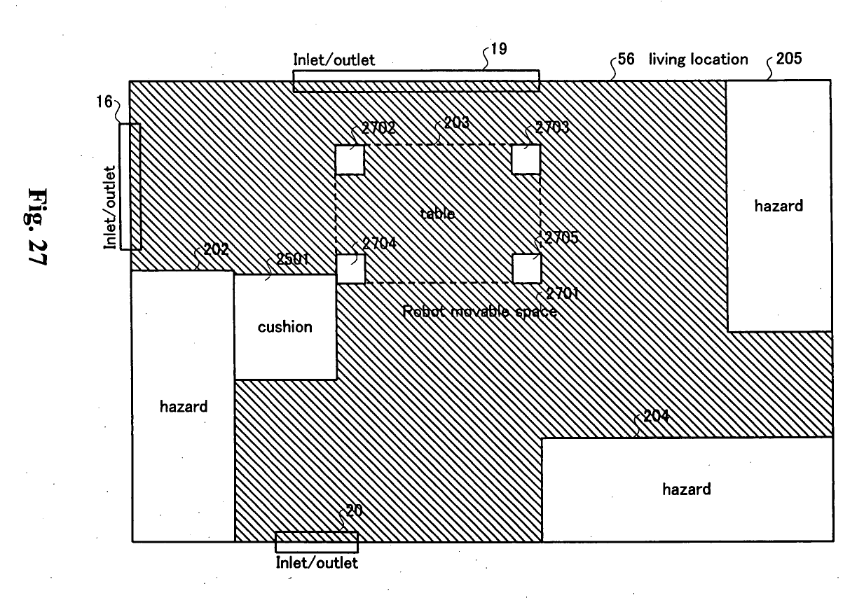

FIG. 26 shows the movable space diagram 1011 when the cushion 2501 is added. The movable space diagram is generated based on the movable space of the user 2. The cushion 2501 does not constitute a hazard for the user 2 since the user 2 can tread over the cushion 2501. The top plate of the table 203 constitutes hazard for the user 2. Therefore, the movable space diagram in this case becomes the same as the movable space diagram exemplified in FIG. 4.

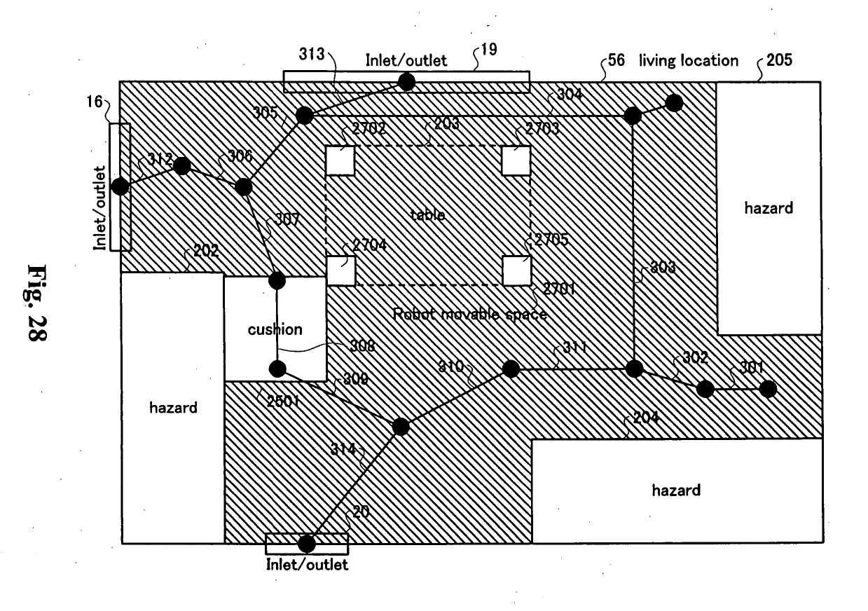

FIG. 27 shows the robot movable space diagram 2401 when the cushion 2501 is added. Although the cushion 2501 and legs 2702 to 2705 at the table 203 constitute hazards for the mobile robot 2301, the top plate of the table 203 does not constitute a hazard since the mobile robot 2301 can pass thereunder.

The path generator 112 works as a path generating device according to an embodiment of the invention, and generates tracking path information based on the movable path data 1010 from the predicted moving path of the user 2 with the user moving path predicting portion 107 and the current position of the mobile robot 2301. The path generator 112 confirms whether there is a hazard by which the robot 1 cannot move on a tracking path from the tracking moving path and the robot movable space diagram 2401, and generates a detour path of moving to the predicted moving path of the user 2. The path generator 112 maintains a constant distance from the hazard when a hazard is determined to be present. Further, the path generator 112 generates a search path for searching the user 2 to a location predicted to have a possibility of presence of the user 2 by the user present location predicting portion 113 from the current position of the mobile robot 2301, or a general path from the movable location constitution data 1001 and paths for respective locations from the movable path data 1010 and the robot movable space diagram 2401.

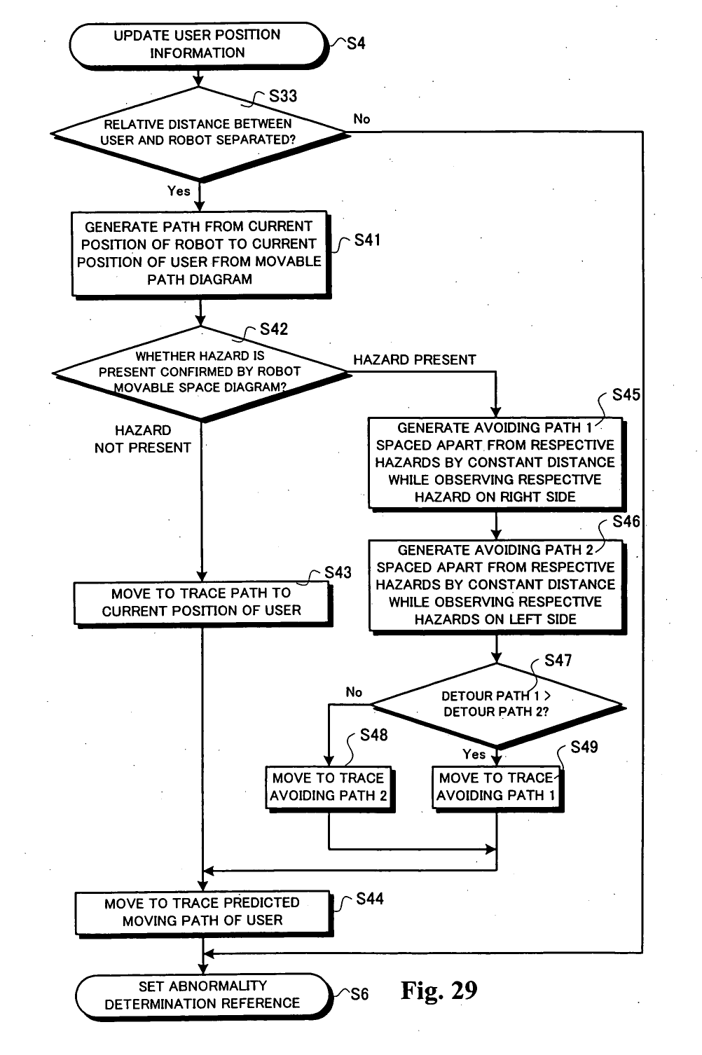

Next, an explanation will be given of processing performed by the mobile robot 2301 according to the embodiment above described. One difference between the first embodiment and the second embodiment resides in the user predicting path step S5. Therefore, FIG. 29 shows in detail a flowchart of a processing procedure of the mobile robot 2301 according to the embodiment in the predicted path step S5.

First, the mobile robot 2301 continues to detect the user 2 by the detector 104 so as not to lose sight of the user 2 from the detecting direction tracking step S4. The relative distance between the mobile robot 2301 and the user 2 is determined from information of coordinates thereof of the movable space diagram 1011g of the mobile robot 2301 and the user 2 (step S33). When the mobile robot 2301 and the user 2 are determined to be separated from each other, the path generator 2303 generates a tracking path of a path from the current position of the mobile robot 2301 to the current position of the user 2 from the movable path data 1010 (step S41). Further, it is determined whether there is a hazard by which the mobile robot 2301 cannot move on the generated tracking path by comparing the tracking path and the robot movable space diagram 2401 (step S42). The determination will be explained in reference to FIG. 28.

FIG. 28 is a diagram overlapping the movable path data 1010 on the robot movable space diagram 2401. In the diagram, when a path of passing the segments 309, 308 is selected as a tracking path of the mobile robot 2301, the path generator 2303 determines that the mobile robot 2301 cannot move to follow the tracking path since there is the cushion 2501 constituting the hazard by which the mobile robot 2301 cannot cross on the tracking path. Under such a situation, the mobile robot 2301 cannot move on the segments 309, 308 with the user 2 and the mobile robot 2301 needs to generate a detour path to track the user 2.

Therefore, when it is determined that the mobile robot 2301 cannot to be moved since there is the hazard (right branch of step S42), the path generator 2303 generates an avoiding path spaced apart from respective hazards and a wall face by a constant distance. The path generator 2303 observes the respective hazards and the wall face on the right side from the robot movable space diagram 2401 having information of a space in which the mobile robot 2301 is movable with regard to a detour path from the current position of the mobile robot 2301 to the current position of the user 2 (step S45). The path generator generates an avoiding path spaced apart from respective hazards and a wall face by a constant distance while observing the respective hazards and the wall face on the right side from the robot movable space diagram 2401 having information of the space in which the mobile robot 2301 is movable (step S46).

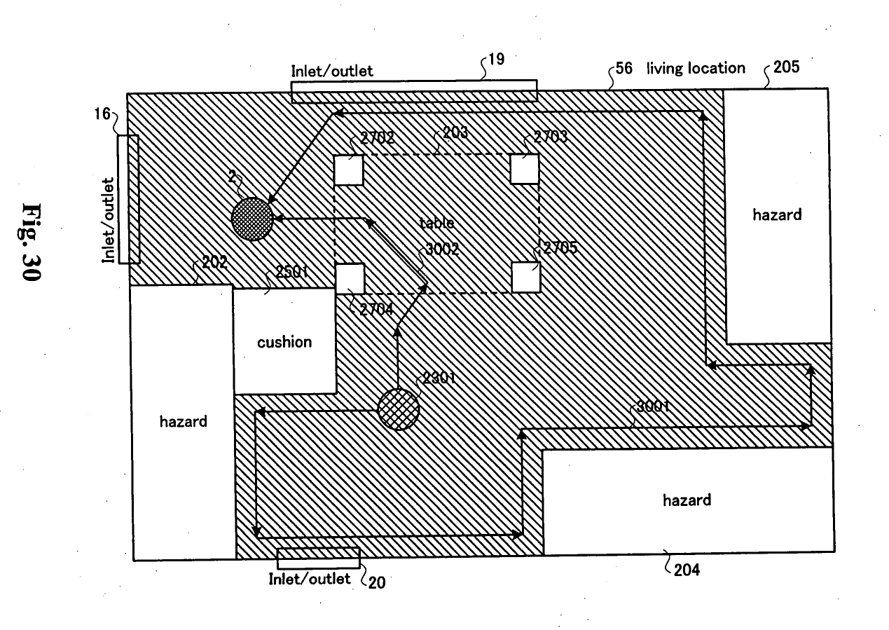

FIG. 30 shows the generated detour paths. A detour path 3001 shows the detour path spaced apart from the respective hazards and the wall face by the constant distance. The detour path observes the respective hazards and the wall face on the right side and a detour path 3002 shows a detour path spaced apart from the respective hazards and the wall face while observing the respective hazards and the wall face on the left side. In this case, in the detour path 3002, the top plate of the table does not constitute a hazard and therefore, it can be confirmed that a shortcut course is utilized in the detour path and robot efficiency is promoted.

Referring back to FIG. 29, the path generator 2303 selects the generated avoiding path having a short moving distance (step S47), and the mobile robot is moved by tracing the selected avoiding path by the drive portion 111 (step S48 or step S49). In the above-described case of FIG. 30, the detour path 3002 is selected and the mobile robot is moved by tracing the detour path 3002.

When there is not a hazard, the mobile robot 2301 is moved from the current position to the current position of the user 2 by tracing the generated tracking path by the drive portion 111 (step S43) Thereafter, the mobile robot 2301 is moved by tracing the predicted path of the user 2 (step S44).

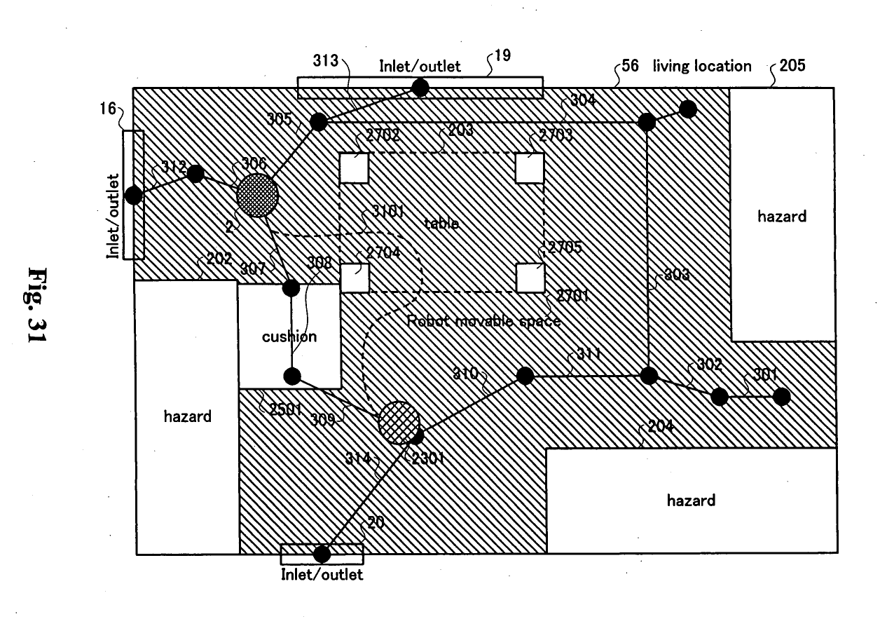

That is, as exemplified in FIG. 31, when the user 2 is moved in the direction of being remote from the mobile robot 2301 on the segment 307, the mobile robot 2301 moves to the segment 307 from the segment 309 by way of the segment 308, however, as described above, the mobile robot 2301 cannot be moved from the segment 309 to the segment 308 past the cushion 2501. Hence, the mobile robot 2301 generates a detour path 3101 reaching the segment 308 from the segment 309 in accordance with a procedure of avoiding the hazard to finish moving along the detour path 3101.

Thereby, even when the user 2 follows a path on which only the user 2 can move, the mobile robot 2301 can select the detour path and follow the detour path. Thereby, efficiency is further promoted.

Also in the user movable path searching step S10 and the base interval movement searching step S13 of FIG. 9, the avoiding path can be generated by a similar procedure.

Further, the movable space diagram 1011 indicating the movable range of the user 2 and the movable space diagram 2401 indicating the movable range of the mobile robot 2301 can automatically be generated after determining whether an object constitutes a hazard in moving the mobile robot 2301 and whether the object constitutes a hazard in moving the user 2 from a shape and a height of the object measured by the detecting means 104 of the mobile robot 2301.

That is, entire regions of a wardrobe, a cushion or the like, or an object having a height which the mobile robot cannot tread such as a leg portion of a table is determined to constitute a hazard for the mobile robot 2301. An object in a range of a constant height from a floor face (height which the user 2 cannot jump over, a height equal to or smaller than a height of the back of the user 2), that is, a leg portion of a wardrobe, or a table, a top plate of a table or the like is determined to constitute a hazard for the user 2, and the mobile robot 2301 generates the movable space diagrams 1011 and 2401.

The mobile robot 2301 according to the embodiment can track the user 2 efficiently even when there is a location at which the mobile robot 2301 cannot move although the user 2 can move. This is accomplished by referring to the robot movable space diagram 2401 indicating a space in which the mobile robot 2301 can move. Further, the mobile robot 2301 can make a shortcut by utilizing a space in which the mobile robot 1 can move although the user 2 cannot. The inventive system conveniently may be implemented using a conventional general purpose computer or microprocessor programmed according to the teachings of the present invention, as will be apparent to those skilled in the computer art. Appropriate software can readily be prepared by programmers of ordinary skill based on the teachings of the present disclosure, as will be apparent to those skilled in the software art.

A general purpose computer may implement the method of the present invention, wherein the computer housing houses a motherboard which contains a CPU (central processing unit), memory such as DRAM (dynamic random access memory), ROM (read only memory), EPROM (erasable programmable read only memory), EEPROM (electrically erasable programmable read only memory), SRAM (static random access memory), SDRAM (synchronous dynamic random access memory), and Flash RAM (random access memory), and other optical special purpose logic devices such as ASICs (application specific integrated circuits) or configurable logic devices such GAL (generic array logic) and reprogrammable FPGAs (field programmable gate arrays).

The computer may also include plural input devices, (e.g., keyboard and mouse), and a display card for controlling a monitor. Additionally, the computer may include a floppy disk drive; other removable media devices (e.g. compact disc, tape, and removable magneto optical media); and a hard disk or other fixed high density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

As stated above, the system includes at least one computer readable medium. Examples of computer readable media include compact discs, hard disks, floppy disks, tape, magneto optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools.

Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs.

The computer program product may also be implemented by the preparation of application specific integrated circuits (ASICs) or by interconnecting an appropriate network of conventional component circuits, as will be readily apparent to those skilled in the art.

1. A mobile robot comprising:
a storage device configured to store movable path information indicating a path on which a subject can move;
a detector configured to detect a position of a subject and a direction of movement of the subject;
a prediction path generator configured to generate a predicted moving path on which the subject is predicted to move based on the movable path information and the detected position and direction of movement; and
a controller configured to direct the detector toward a moving direction of the subject predicted by the prediction path generator.

2. A mobile robot comprising:
a storage device configured to store current position information and movable path information indicating a path on which a subject can move;
a detector configured to detect a position of a subject and a direction of movement of the subject;
a prediction path generator configured to generate a predicted moving path on which the subject is predicted to move based on the movable path information and the detected position and direction of movement;
a tracking path generator configured to generate a tracking path indicating a path of tracking the subject based on the current positions of the robot and the subject, and the predicted moving path of the subject; and
a moving unit configured to move in accordance with the tracking path.

3. The mobile robot according to claim 1, wherein:
the prediction path generator is configured to, upon a failure to detect the subject, generate the predicted moving path based on the subject position information last detected by the detector and the movable path information.

4. The mobile robot according to claim 2, wherein:
the prediction path generator is configured to, upon a failure to detect the subject, generate the predicted moving path based on the subject position information last detected by the detector and the movable path information.

5. The mobile robot according to claim 2, wherein:
the storage device is further configured to store robot movable space information indicating space in which the mobile robot can be moved;
the tracking path generator is configured to determine whether there is a hazard hampering the mobile robot moving on the tracking path based on hazard information stored in the storage device and to generate a detour path to detour the hazard based on the robot movable space information when there is the hazard; and
the moving unit is configured to move in accordance with the detour path.

6. The mobile robot according to claim 4, wherein:
the storage device is further configured to store robot movable space information indicating space in which the mobile robot can be moved;
the tracking path generator is configured to determine whether there is a hazard hampering the mobile robot moving on the tracking path based on hazard information stored in the storage device and is configured to generate a detour path to detour the hazard based on the robot movable space information when there is the hazard; and
the moving unit is configured to move in accordance with the detour path.

7. The mobile robot according to claim 2, further comprising:
the storage device configured to store current location information and movable location constitution information indicating a path of the subject between locations;
a presence location prediction unit configured to calculate a predicted subject destination location indicating a location to which the subject has moved via a path predicted based on the predicted moving path information and a duration of time from a time of last detecting the subject, and configured to specify other respective locations to which the mobile robot can be moved based on the predicted moving destination. location by the movable constitution information, to calculate a subject presence expected value indicating the probability of presence of the subject at the predicted moving direction location and the other respective locations;
the tracking path generator configured to generate a searching path indicating a path of searching the subject while moving to the locations in a descending order starting with locations with the highest subject presence expected values; and
the moving unit configured to move in accordance with the searching path information.

8. The mobile robot according to claim 4, further comprising:
the storage device configured to store current location information and movable location constitution information indicating a path of the subject between locations;
a presence location prediction unit configured to calculate a predicted moving destination location to which the subject has moved via a path predicted by the prediction path generator based on duration of time from a time of last detecting the subject and the movable base constitution information stored in the storage device, specify other respective locations to which the mobile robot can move from the predicted moving destination location based on the movable constitution information, calculate a subject presence expected value indicating a probability of presence of the subject at the predicted moving destination location and the other respective locations, and generate a presence location expected value which equals the expected value of the subject being in the respective locations;
the tracking path generator configured to generate searching path information indicating a path of searching the subject while the robot moves to the locations in an order of locations having the highest subject presence expected values based on the location constitution information and inter-location moving path information indicating a path of moving from one location to another location by the movable path information; and
the moving unit configured to move in accordance with the searching path information.

9. The mobile robot according to claim 2, further comprising:
the storage device configured to store current location information and movable location constitution information indicating a path of the subject between locations;
a presence location prediction unit configured to calculate a predicted moving destination location indicating a location of a destination to which the subject has moved via a path predicted by the prediction path generator based on a duration of time from the time of last detecting the subject and a moving distance to the location determined based on geometrical shapes of the locations, specify other respective locations accessible to the subject from the predicted moving destination location based on the movable constitution location information, calculate a subject presence expected value indicating a probability of presence of the subject at the predicted moving destination location and the respective locations;
the tracking path generator configured to generate a searching path such that the robot moves to the locations in a descending order starting with the locations having the highest subject presence expected values; and
the moving unit configured to move in accordance with the searching path information.

10. The mobile robot according to claim 4, further comprising:
the storage device configured to store current location information and movable location constitution information indicating a path of the subject between locations;
a presence location prediction unit configured to calculate a predicted moving destination location indicating a location to which the subject has moved via a path predicted by the prediction path generator based on a duration of time from time of last detecting the subject and a moving distance to the location determined based on geometrical shapes of the locations, the current location information, and the movable location constitution information, specify other respective locations accessible to the subject from the predicted moving destination location based on the movable constitution location information, calculate a subject presence expected value indicating a probability of presence of the subject at the predicted moving destination location and the respective locations;
the tracking path generator configured to generate a searching path such that the robot moves to the locations in a descending order starting with the locations having the highest subject presence expected values; and
the moving unit configured to move in accordance with the searching path information.

11. A mobile robot comprising:
a storage device configured to store abnormality determination reference information indicating a determination reference for detecting an abnormality at respective locations to which a subject may move;
a detector configured to detect action information indicating a sound made by the subject in the location in which the subject is present;
an abnormality determination reference setting unit configured to set the abnormality determination reference information stored in the storage device in correspondence with the location where the subject is present; and
an abnormality determining unit configured to determine whether the action information detected by the detector is abnormal based on the abnormality determination reference information set by the abnormality determination reference setting unit.

12. The mobile robot according to claim 11, further comprising:
the storage device configured to store current position information and movable path information indicating a path on which the subject can move;
the detector configured to detect the subject and to acquire subject position information indicating a position and a direction of movement of the detected subject;
a prediction path generator configured to generate predicted moving path information indicating a path on which the subject is predicted to move based on the movable path information stored on the storage device and the subject position information detected by the detector;
a tracking path generator configured to generate tracking path information showing a path of tracking the subject based on a current positions of the subject and mobile robot, and the path on which the subject is predicted to move; and
a moving unit configured to move in accordance with the tracking path information generated by the tracking path generator.

13. The mobile robot according to claim 11, wherein the abnormality determining unit is configured to determine an abnormality when action information is not detected by the detector in the location where the subject is present.

14. The mobile robot according to claim 12, wherein the abnormality determining unit is configured to determine an abnormality when action information is not detected by the detector in the location where the subject is present.

15. The mobile robot according to claim 11, wherein the abnormality determining unit is configured to determine an abnormality when a second action information is not detected until expiration of a time period since a first action information was detected by the detector.

16. The mobile robot according to claim 12, wherein the abnormality determining unit is configured to determine an abnormality when a second action information is not detected until expiration of a time period since a first action information was detected by the detector.

17. The mobile robot according to claim 12, wherein the abnormality determining unit is configured to determine an abnormality when the subject is detected as not having moved for a predetermined amount of time since the last action information was detected by the detector.

18. The mobile robot according to claim 11, further comprising:
an abnormality detection informing unit configured to create an output when an abnormality is determined by the abnormality determining unit.

19. A method of monitoring a subject, comprising:
first detecting a location of a subject by means of at least one sensor mounted on a mobile robot;
monitoring movement of the subject based on changes of a detected location of the subject;
moving the mobile robot to maintain proximity between the subject and the mobile robot;
second detecting at least one characteristic of the subject at one or more locations of the mobile robot;
outputting a signal representative of the detected characteristic of the subject.

20. The method of claim 19, wherein the detected characteristic of the subject is an amount of time between detection of a first action of the subject and detection of a second action of the subject.

21. The method of claim 20, wherein at least one of the first action and second action is the creation of a sound.

22. The method of claim 20, wherein at least one of the first action and second action is the movement of the subject.

23. The method of claim 19, wherein the detected characteristic of the subject relates to the location of the subject.

24. The method of claim 19, wherein moving the mobile robot further comprises:
storing, in a storage portion of the mobile robot, map information indicating portions of a local area designated as accessible to the subject and portions of the local area designated as accessible to the mobile robot; and
calculating a predicted path of the subject based on location and movement of the subject and based on the portions designated as accessible to the subject.

25. The method of claim 24, further comprising:
calculating a tracking path based on the predicted path of the subject and the portions designated as accessible to the mobile robot; and
moving the robot along the tracking path.

26. The method of claim 24, further comprising:
when the subject is out of a sensor detection range of the mobile robot, calculating an expected probability of the subject being in another location on the map based on the portions designated as accessible to the subject, a location where the subject was last detected, a time since the subject was last detected, and the predicted path of the subject.

27. The method of claim 24, further comprising:
moving the mobile robot to locations on the map in order of descending expected probability of the subject being in the location until the mobile robot detects the subject.

28. A mobile robot comprising:
a storage device configured to store a map of a locality;
a detector configured to detect action of a subject within a detection range;
means for maintaining the detector in proximity to the subject; and
means for determining at least one characteristic of the subject.

29. The mobile robot of claim 28, wherein the at least one characteristic of the subject is the time between detecting a first action of the subject and detecting a second action of the subject.

30. The mobile robot of claim 29, wherein at least one of the first action and the second action is the creation of a sound.

31. The mobile robot of claim 29, wherein at least one of the first action and the second action is the movement of the subject.

32. The mobile robot of claim 28, wherein the at least one characteristic of the subject relates to the location of the subject.

33. A computer program product which stores computer program instructions which, when executed by a computer programmed with the computer program instruction, results in performing the steps comprising:
receiving first data from a first sensor mounted on a mobile robot and determining the location of a subject based on the received first data;
determining changes of a detected location of the subject based on the first data;
generating drive signals to a movement portion of a mobile robot to maintain proximity between the subject and the mobile robot;
receiving second data from a second sensor at one or more locations of the mobile robot, said second data related to at least one characteristic of the subject; and
outputting a signal representative of the detected characteristic of the subject.

34. The computer program product of claim 33, wherein the second data is an amount of time between a first action of the subject and a second action of the subject.

35. The computer program product of claim 34, wherein at least one of the first action and the second action is the creation of a sound.

36. The computer program product of claim 34, wherein at least one of the first action and the second action is the movement of the subject.

37. The computer program product of claim 33, wherein said steps further comprise: analyzing the received second data based on the received first data.

38. The computer program product of claim 33, wherein said steps further comprise:
storing map information indicating portions of a local area designated as accessible to the subject and portions the local area designated as accessible to the mobile robot; and
calculating a predicted path of the subject based on the received first data, the determined changes of a detected location of the subject and the portions designated as accessible to the subject.

39. The computer program product of claim 38, wherein said steps further comprise:
calculating a tracking path based on the predicted path of the subject and the portions designated as accessible to the mobile robot; and
generating drive signals to a movement portion of a mobile robot to move the mobile robot along the tracking path.

40. The computer program product of claim 38, wherein said steps further comprise:
calculating, when the subject is out of detection range of the at least one sensor mounted on a mobile robot, the expected probability of the subject being in another location on the map based on the first data received, an amount of time since receiving the first data, the portions designated as accessible to the subject, and the predicted path of the subject.

41. The computer program product of claim 38, wherein said steps further comprise:
generating signals to a movement portion of a mobile robot to move the mobile robot to locations on the map in order of descending expected probability of the subject being in the location until the mobile robot detects the subject.
